(19) United States
(12) Patent Application Publication
(10) Pub. No.: US 2013/0085835 A1
(43) Pub. Date: Apr. 4, 2013

(54) APPLYING MOBILE DIGITAL COUPONS AT THE POINT OF SALE

(71) Applicant: Coupons.com Incorporated, Mountain View, CA (US)

(72) Inventor: Steven M. Horowitz, Los Altos, CA (US)

(73) Assignee: Coupons.com Incorporated, Mountain View, CA (US)

(21) Appl. No.: 13/632,988

(22) Filed: Oct. 1, 2012

Related U.S. Application Data
(60) Provisional application No. 61/542,149, filed on Sep. 30, 2011.

(51) Int. Cl. G06Q 30/02

(52) U.S. Cl. 705/14.38; 705/14.1

(57) ABSTRACT

During a transaction involving a customer purchasing items at a terminal, one or more of coupon data, basket data, or a token are transferred between the terminal and a mobile device associated with the customer, via a proximity-based link. The proximity-based link may be established, without limitation, via NFC, RFID, or other short-range interfaces. For example, a customer may place an NFC component embedded in the customer's mobile device near an NFC component of the terminal. Various techniques are described for causing one or more coupons to be applied to the transaction based on the information transferred over the proximity-based link.

### CROSS-REFERENCE TO RELATED APPLICATIONS; BENEFIT CLAIM

This application claims the benefit of Provisional Application 61542149, filed Sep. 30, 2011, the entire contents of which is hereby incorporated by reference as if fully set forth herein, under 35 U.S.C. §119(e).

### FIELD OF THE INVENTION

Embodiments relate generally to coupon systems, and, more specifically, to techniques for utilizing digital coupons at a point of sale.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In general, a coupon is a certificate that entitles its holder to accept an offer described or referenced by the coupon. The offer, also subsequently referred to as the “coupon offer,” may be any type of offer, but is in general an offer by the coupon provider to provide a customer with one or more goods or services at a typically discounted price, or to provide the customer with a gift in exchange for the performance of an act, such as purchasing a good or service. In one embodiment, a coupon offer is a discount that requires a purchase of a consumer packaged good (“CPG”). A coupon often takes a “hard copy” form, such as a paper certificate, printed on which are images and/or text describing terms of the offer. The process of the user accepting a coupon offer by purchasing, contracting, or otherwise transacting with another party shall hereinafter be referred to as “redeeming” the coupon. For example, a customer may redeem a hard copy of a coupon by handing the copy to a clerk during a purchase at a retail store.

While coupons have conventionally been distributed to customers by hand, such as via mail or newspapers, recent distribution techniques now provide customers with opportunities to print their own coupons. For example, a number of websites provide search engines with which users may search for offers and then print coupons for the offers they find. Some of these websites may employ mechanisms to control the number of times that a given offer may be printed by a customer, by a device, and/or in aggregate. The printed coupons may be used in the same manner as any other coupon. However, a downside to techniques that require customers to print their own coupons is that customers may not be near a functional printer from which they can print a coupon at the time they find an offer of interest. The customer may then be unwilling or unable to take the time to access a printer before shopping.

To take advantage of coupon offers at a store, a customer must typically bring the coupons corresponding to the offers to the store. However, the planning required to ensure that the customer is carrying a coupon to which the customer is entitled when visiting a store can be greatly inconvenient, especially if the customer does not have well-structured shopping habits. Moreover, if a customer has many coupon offers to redeem, bringing the necessary coupons to a store can impose an extra burden on the customer. It may be especially difficult to organize coupons if the customer has many coupons for different stores or for different items. Even if the customer has coupons available to him at the store, sorting through coupons during a checkout can be further inconvenient to the user.

For this and other reasons, some customers do not perceive certain types of coupon offers as being valuable enough for the customer to view an offer and/or obtain a coupon for the offer. In turn, from a retailer or advertiser perspective, the value of a coupon campaign may therefore be diminished.

### BRIEF DESCRIPTION OF THE DRAWINGS

In the drawings:

FIG. 1 is a block diagram of an example system in which the techniques described herein may be practiced;

FIG. 2 is a block diagram illustrating an example system in which the techniques described herein may be practiced;

FIG. 3 illustrates a flow for utilizing a mobile device to apply digital coupons at a point-of-sale; and

FIG. 4 illustrates a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Approaches, techniques, and mechanisms are disclosed for utilizing a consumer's mobile device to apply digital coupons at a point of sale. According to an embodiment, a retailer adds identifiers for one or more products and/or services (hereinafter collectively “items”) to a set of items (hereinafter “basket”) that are to be purchased in a transaction involving the customer at the retailer's point-of-sale. For example, a cashier may “ring up” groceries from a customer's shopping cart using a register. The item identifier(s) are maintained, at least temporarily, at a computing device operated by the retailer (hereinafter “terminal”). The customer, at the point-of-sale, initiates a transfer of information from the customer's mobile device to the terminal via a proximity-based link. For example, the customer may temporarily bring, or “swipe,” a Near-Field Communication (“NFC”)-enabled phone near an NFC reader to transmit information to the terminal. Alternatively, the reader may instruct an application on the customer's mobile phone to encode and send such the information to the terminal over any of a variety of wireless technologies, such as Bluetooth, Wi-Fi, radio frequency signals, audio signals, video signals, or infrared signals. Based on the information transferred from the mobile device, the one or more digital coupons are applied to the transaction. The customer may then proceed to provide payment information, which may in some embodiments also be provided via the information transferred from the mobile device.

In another embodiment, the customer inputs the necessary information directly into a terminal, or add-on component coupled thereto, rather than instructing the mobile device to transfer the information. For example, the user may input a telephone number and a personal identification number. The inputted information may then be utilized as both payment information and as identifying information for the purpose of locating the digital coupon(s). Alternatively, the inputted information may then be utilized to identify coupons of the user, while payment may be obtained separately.

A number of different techniques are described herein for causing the one or more digital coupons to be applied to the transaction. These techniques vary in a number of aspects, including what type of information is transmitted between the mobile device and the terminal, how and where the one or more digital coupons to apply to the transaction are actually identified, and how the transaction is actually conducted. The exact technique used for any given transaction may thus vary depending on the infrastructures and technologies supported by the retailer, the mobile device, the payment mechanism(s), and/or the coupon distributor.

### I. General Overview

In an embodiment, a method comprises: at a point-of-sale terminal belonging to a retailer, receiving basket data specifying one or more item identifiers for one or more items to purchase in a transaction; at a sensor coupled to the point-of-sale terminal, receiving a wireless signal from a mobile device, the wireless signal carrying token data; locating an identifier based on the token data; sending a request over a network to a coupon server, the request comprising the identifier, wherein the coupon server is a server configured to receive requests that include identifiers from a plurality of different retailers; responsive to the request, receiving from the coupon server digital coupon availability data, the digital coupon availability data specifying one or more coupon offers available to an account associated with the identifier; comparing the one or more item identifiers in the basket to one or more item identifiers associated with the one or more coupon offers specified in the digital coupon availability data to identify a particular coupon offer to apply to the transaction; applying the particular coupon offer to the transaction by adjusting a total amount to charge for the transaction in accordance with one or more terms of the particular coupon offer; sending transaction information and at least a portion of the token data to a payment server, wherein the transaction information specifies the adjusted total amount to charge for the transaction; receiving, from the payment server, an indication that the transaction has been authorized; providing to the terminal an indication that the transaction has successfully completed.

In an embodiment, receiving the wireless signal comprises receiving a signal via a Near-Field Communications reader. In an embodiment, the identifier is one of an account identifier, device identifier, or payment identifier specified in the token data. In an embodiment, the portion of the token data sent to the payment server is the identifier sent to the coupon server. In an embodiment, the coupon server is the same as the payment server. In an embodiment, at least the steps of locating the identifier, sending the request, receiving the digital coupon availability data, comparing the one or more item identifiers, and sending the transaction information are performed by a retail server coupled to the terminal.

In an embodiment, a method comprises: receiving, at a server, coupon data from a plurality of coupon providers, the coupon data specifying a plurality of different coupon offers for which the coupon server is to distribute digital coupons; receiving, at the server, registration data for a plurality of accounts, each account associated with one or more Near Field Communication tokens; the server storing account data associating different sets of one or more digital coupons for the plurality of different coupon offers with different accounts of the plurality of accounts; receiving, at the server, requests for digital coupon availability data, each particular request of the requests including a particular Near Field Communication token; responsive to each particular request of the requests: identifying a particular account associated with the particular request; identifying a set of one or more digital coupons associated with the particular account; and sending particular digital coupon availability data in response to the particular request, the particular digital coupon availability data specifying the set of one or more digital coupons.

In an embodiment, the requests are from a plurality of different retail servers operated by a plurality of different retailers. In an embodiment, the requests are from one or more payment servers. In an embodiment, each particular request includes basket data specifying one or more item identifiers involved in a transaction associated with the particular request, and identifying a set of one or more digital coupons associated with the particular account comprises selecting the set of one or more digital coupons from a plurality of digital coupons associated with the particular account based on the item identifiers.

In an embodiment, a method comprises: receiving, at a server, registration data for a plurality of payment accounts, each payment account associated with one or more Near Field Communication tokens; receiving, at the server, transaction requests from a plurality of different retailers to complete transactions at a plurality of different points-of-sale operated by the plurality of different retailers; wherein each particular transaction request of the plurality of transaction requests includes particular transaction information specifying particular basket data comprising one or more item identifiers involved in a particular transaction associated with the particular transaction request, and a particular Near Field Communication token; and responsive to each particular transaction request of the plurality of transaction requests, the server: sending the particular Near Field Communication token corresponding to the particular transaction request to a coupon server; receiving, from the coupon server, data describing one or more digital coupons associated with the particular Near Field Communication token; identifying at least a particular digital coupon of the one or more digital coupons to apply to the particular transaction information; calculating a total transaction amount based on applying at least the particular digital coupon to the particular transaction information; and causing a particular retailer that sent the particular transaction request to receive funds based on the calculated total transaction amount.

In an embodiment, responsive to each particular transaction request of the plurality of transaction requests, the server sending the particular basket data to the coupon server in association with the particular Near Field Communication token. In an embodiment, responsive to each particular transaction request of the plurality of transaction requests, the server compares the particular basket data to the data describing the one or more digital coupons to identify which particular digital coupon to apply to the particular transaction information. In an embodiment, the server receives the same Near Field Communication token in different transaction requests from different retailers of the plurality of retailers. In an embodiment, the coupon server is a component of the server.

In an embodiment, a system comprises: a coupon server, executing at a first set of one or more computing devices, configured to: receive coupon data from a plurality of coupon providers, the coupon data specifying a plurality of coupon offers for which the coupon server distributes digital coupons; and provide digital coupons for one or more selected coupon offers of the plurality of coupon offers in response to coupon requests received over one or more networks; a payment server, executing at a second set of one or more computing devices, configured to: receive payment requests over the one or more networks, the payments requests indicating amounts to charge particular payment accounts; and respond to the payment requests over the one or more networks with responses indicating whether each particular payment request was authorized; wherein the coupon server and the payment server are further configured to receive, in particular requests over the one or more networks, particular token data sensed in wireless signals during transactions at terminals belonging to a plurality of different retailers; one or more database systems storing mapping data that associates token data with payment accounts and coupon accounts; wherein the coupon server is further configured to, for each particular coupon request of a plurality of the coupon requests: identify a coupon account associated with particular token data included in the particular coupon request; select one or more coupon offers associated with the account; and respond to the particular coupon request with digital coupon information for the one or more coupon offers associated with the account; wherein the payment server is further configured to, for each particular payment request of a plurality of the payment requests: identify a payment account associated with particular token data included in the particular payment request; and based on the payment account, determine whether to authorize a transaction associated with the particular payment request.

In an embodiment, the system further comprises retail servers belonging to the plurality of different retailers, executing at a plurality of third sets of one or more computing devices, each coupled to a different set of the terminals and one or both of the payment server and coupon server; wherein the retail servers are configured to, responsive to a first request from a first terminal that includes first token data, send a first coupon request comprising the first token data to the coupon server and send a first payment request comprising the same first token data to the payment server.

In an embodiment, each particular token data is a Near Field Communication token. In an embodiment, the first set of computing devices is the same as the second set of computing devices. In an embodiment, the payment server is further configured to: send at least some of the coupon requests to the coupon server; and apply digital coupons provided by the coupon server to transactions described in the payment requests.

In other aspects, the invention encompasses a computer apparatus and a computer-readable medium configured to carry out the foregoing steps.

### II. Structural Overview

The techniques described herein are applicable to a number of different coupon infrastructures. Examples of suitable infrastructures are described, without limitation, in application Ser. No. 12/878,231, filed Sep. 9, 2010, application Ser. No. 12/896,206, filed Oct. 1, 2010, application Ser. No. 13/100,219, filed May 3, 2011, and application Ser. No. 61/442,745, filed Feb. 14, 2011, the entire contents of each of which are hereby incorporated by reference for all purposes as if fully set forth herein.

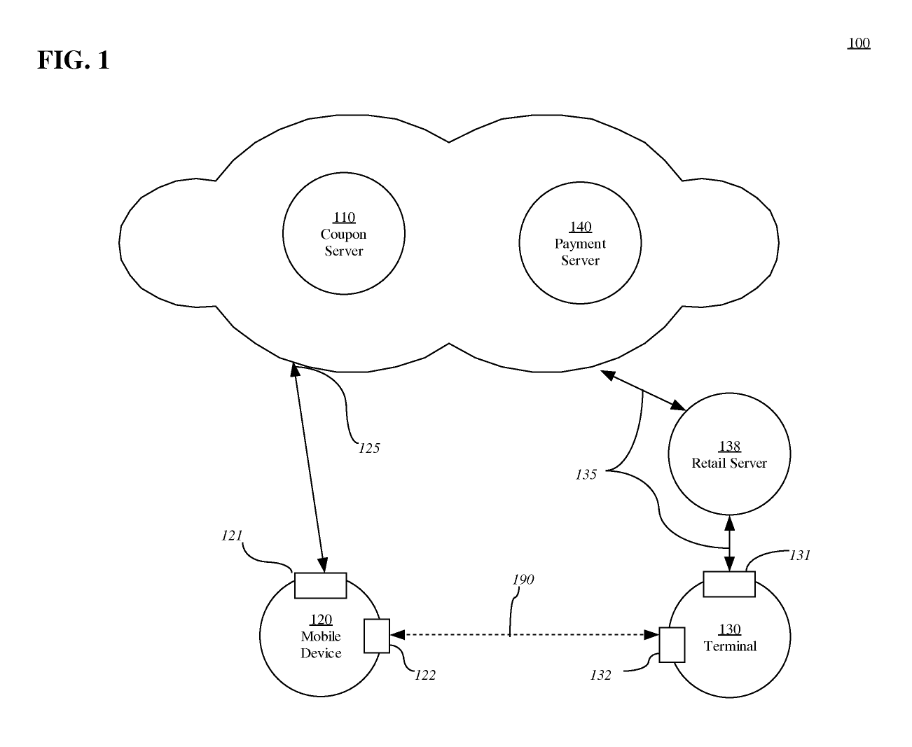

FIG. 1 is a block diagram of an example system 100 in which the techniques described herein may be practiced, according to an embodiment. System 100 comprises the following active components: a coupon server 110, a mobile device 120, a terminal 130, and, optionally, a retail server 138 and/or a mobile payment server 140.

Coupon server 110 may be a set of one or more components, implemented by any combination of hardware and software at one or more computing devices. The components collectively work together to provide “cloud-based” coupon services to mobile device 120 and terminal 130. In an embodiment, coupon server 110 is implemented by a coupon distributor that distributes digital coupons on behalf of one or more coupon providers, such as retailers or manufacturers.

Mobile payment server 140 may be a set of one or more components, implemented by any combination of hardware and software at one or more computing devices. The components collectively work together to provide “cloud-based” payment services to mobile device 120 and terminal 130. In an embodiment, mobile payment server 110 is implemented by an electronic funds transfer (“EFT”) provider such as a credit card company, bank, or online payment service, to allow a customer to transfer funds to a retailer via mobile device 120. Mobile payment server 140 may, in an embodiment, be the same as or overlap with coupon server 110.

Coupon server 110 and mobile payment server 140 are connected to each of mobile device 120 and terminal 130 remotely, via networks 125 and 135 respectively. Networks 125 and 135 may comprise any number of communication nodes and links, and in fact may even contain overlapping elements. In an embodiment, network 125 comprises mobile data components, such as cellular or Wi-Fi networks. In an embodiment, network 135 comprises a retailer intranet or firewall. Communications across both networks may be secured using any suitable encryption protocol. Networks 125 and 135 are collectively referred to as the “backend” throughout this application. Most of the communication between components of system 100 described herein may occur over networks 125 and 135.

In an embodiment, mobile device 120 is a wireless, portable, and/or battery powered computing device that the customer commonly keeps with him or her while traveling, such as a phone, tablet, personal digital assistant, watch, and so forth. However, mobile device 120 may in fact be any computing device that the customer has logged in to. Mobile device 120 is configured to execute instructions for a graphical coupon client interface by which the customer communicates with coupon server 110. The coupon client interface may be provided by, for instance, a mobile application or a web application. In an embodiment, mobile device 120 is further configured to execute instructions for a graphical mobile payment interface by which the customer communicates with payment server 140. The mobile payment interface and coupon client interface may be integrated or separate. The interfaces may be activated by customer input, in response to unsolicited communications from coupon server 110 or mobile payment server 140, and/or in response to signals received from terminal 130.

Terminal 130 is a computing device operated by a retailer for conducting in-store (i.e. “point of sale” or “brick and mortar”) transactions. Terminal 130 may be, for example, a register operated by a sales clerk, or a “self-checkout” stand. Terminal 130 comprises input mechanisms by which a clerk and/or the customer may input information for conducting a transaction, including item identifiers and item quantities. The input mechanisms may include, without limitation, keyboards, pointing devices, touch screens, bar-code readers, cameras, scales, and radio frequency identification (“RFID”) readers. Terminal 130 is coupled to a database of item identifiers, in which each item identifier is mapped to one or more prices. Terminal 130 may further comprise or be coupled to one or more payment mechanisms, such as a cash register, check verification system, or credit card reader.

In an embodiment, terminal 130 is further coupled to retail server 138 in network 135. Retail server 138 coordinates transactions amongst a plurality of terminals. Retail server 138 is implemented by any combination of hardware or software components at one or more computing devices located in-store and/or at a regional location away from the store. Retail server 138 is an optional component of system 100. However, in an embodiment, some or all of the communication to and from terminal 130 passes through retail server 138. Moreover, in an embodiment, any number of functions described herein as being performed by a terminal such as terminal 130 may in fact be performed, at least in part, by retail server 138. In an embodiment, terminal 130 is a “thin client,” and all functions other than input and output are shifted to retail server 138.

Mobile device 120 comprises at least a backend interface 121 for sending and receiving information via network 125 and a proximity interface 122 for sending signals to or receiving signals from terminal 130. Similarly, terminal 130 may comprise a backend interface 131 for sending and receiving information via network 135, and a proximity interface 132 for sending signals to or receiving signals from mobile device 120. Backend interface 121 may comprise, for example, a Wi-Fi, cellular data, or other mid-to-long range wireless communication chip. Backend interface 131 may comprise an Ethernet chip or other wired networking chip. Backend interface 131 may also or instead comprise a mid-to-long range wireless communication chip.

Proximity interfaces 122 and 132, by contrast, may each comprise a chip configured for short range communication, such as a NFC or other RFID chip, or an infrared or optical signal transmission chip. In an embodiment, proximity interface 122 and proximity interface 132 may comprise a speaker and/or a microphone for transmitting data that has been encoded as audio signals.

Communications via proximity interfaces 122 and 132 occur via a proximity-based link 190. Proximity-based link 190 may comprise a unidirectional or bidirectional transfer of signals between the proximity interfaces of mobile device 120 and terminal 130. In an embodiment, proximity-based link 190 is temporary in nature, formed only when proximity interfaces 122 and 132 are brought within a certain proximity of each other, such as in response to a customer “swiping” a phone or bringing an audio component of the mobile device 120 within “hearing” distance of a speaker at terminal 130. In an embodiment, proximity-based link 190 exists for only the duration of the transaction. In an embodiment, proximity-based link 190 exists for only a brief period of time, no longer than a few seconds.

In an embodiment, one of proximity interfaces 122 and 132 may be passive, in that it is only capable of transmitting signals. In such an embodiment, the passive interface need not actually be in communication with or even physically linked to any component of mobile device 120 or terminal 130, as long as the passive interface is logically associated with mobile device 120 or terminal 130. For example, a retailer may deploy a passive NFC tag adjacent to terminal 130 that transmits an identifier or token that has been uniquely assigned to terminal 130.

Proximity interfaces 122 and 132 need not necessarily comprise short range communication chips, as long as communications over link 190 during a transaction are sent in a manner so as to reasonably indicate that the transmissions sent and received during the transaction do in fact originate from the mobile device 120 of the customer and the terminal 130 that is processing the transaction. In an embodiment, proximity interface 122 comprises a graphical application or web interface, by which a customer inputs information that is communicated to the customer visually or aurally during the transaction, such as a token displayed by terminal 130. In the embodiment, then, proximity interface 132 of terminal 130 would be replaced by the output mechanism that displayed, announced, or printed the token.

### III. Digital Coupons

In an embodiment, a coupon server such as coupon server 110 generates digital coupons for various coupon offers from third-party manufacturers. The coupon server may generate the digital coupons in response to a variety of events, such as a customer requesting a digital coupon for a specific coupon offer, or a manufacturer or retailer requesting that the coupon server send an offer to a customer. Examples of suitable techniques for generating digital coupons are described in the above-referenced patent applications.

In an embodiment, the coupon server saves digital coupons to different “accounts” belonging to different customers or sets of customers. The coupon server provides information about the coupons available in a given account to customers and retailers. When a coupon that has been saved to an account is redeemed in a transaction, the coupon server may remove the coupon from the account. The coupon server may furthermore periodically share information about some or all the coupons saved to a customer's account. For example, the coupon server may share the information with a retail server or payment server, so that the retail server or payment server has a cached copy of the coupons that have been saved to a customer's account. As another example, the coupon server may share a list of coupons saved to a customer's account with the customer's mobile device, such as mobile device 120. In either case, the entity with which coupons are shared should be configured to synchronize the list of available coupons periodically and/or in response to actions such as coupon redemption or coupon deletion.

In an embodiment, the coupon server dispenses digital coupons directly to mobile devices rather than storing the digital coupons itself. In such embodiments, the coupon actually resides upon the mobile device. A coupon client component at the mobile device takes various measures such as encrypting the digital coupon to ensure that the digital coupon cannot be illegally copied.

In an embodiment, the coupon server dispenses digital coupons directly to retail servers rather than store the digital coupons itself. The retailer is then configured to store the digital coupon in a customer's account. In the embodiment, because coupon storage occurs at a retailer's server as opposed to a coupon provider's server, the digital coupons can only be used at the retailer that operates the retail server at which the digital coupons were stored.

In an embodiment, some or all of the digital coupons generated by a coupon server are unique. As such, each digital coupon is associated with a different unique identifier. The coupon server enforces constraints upon the use of each unique digital coupon. For example, the coupon server may invalidate a unique digital coupon after a certain number of uses. In an embodiment, each digital coupon is generated specifically for a single customer, and may only be used once.

### IV. Example Functional Overview

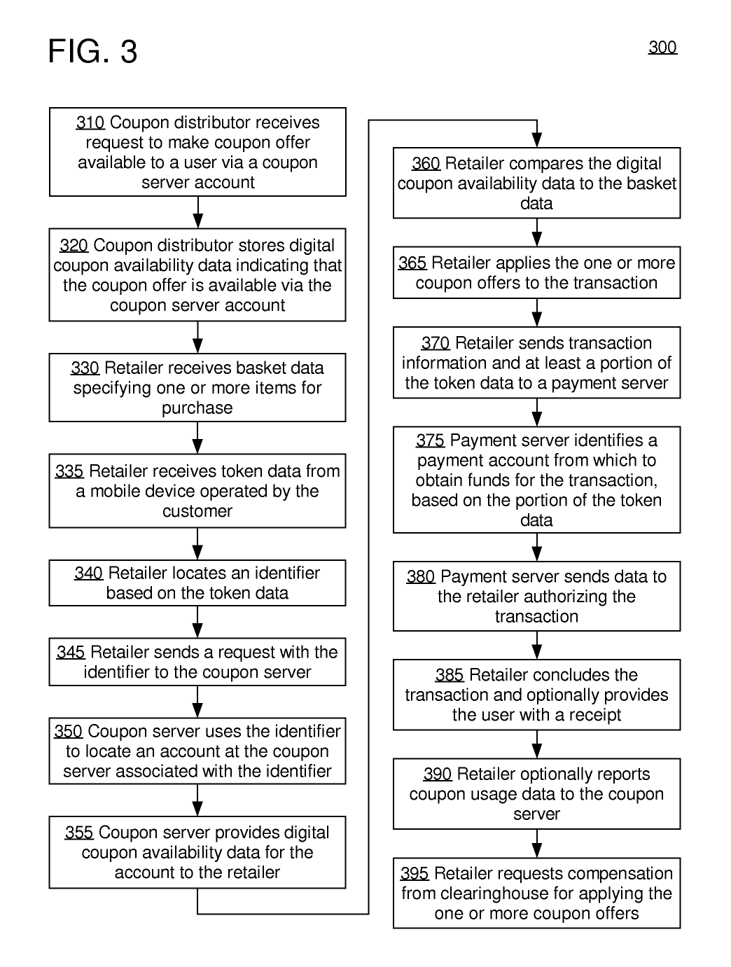

FIG. 3 illustrates a flow 300 for utilizing a mobile device to apply digital coupons at a point-of-sale, according to an embodiment.

At block 310, a coupon server, such as coupon server 210, receives a request indicating that a coupon offer should be made available to a user via the user's coupon server account. The request may be received as a result of input from the user at client 220. For example, the user may issue a one-time request to save a particular offer to user's account. Or, the user may issue a request to automatically and/or periodically add a category of offers to the user's account, including the particular offer.

The request may instead be received from an entity other than the user. For example, the request may be received from a retailer or a coupon provider that wishes to provide the coupon offer to the user. In such a case, the request may even have been received without the user having explicitly requested access to the coupon offer. As another example, the coupon distributor may itself request that the distribution server associate the coupon with the one or more account identifiers.

At block 320, in response to the request, the coupon server stores digital coupon availability data indicating that the coupon offer is available via the user's coupon server account. In an embodiment, the digital coupon availability data may optionally further restrict the availability of the coupon offer to transactions in which a user presents one or more specific identifiers associated with the user's account. For example, the coupon server may determine that the coupon offer is not accepted by the retailer with which a certain account identifier was established, and thus not associate the coupon offer with that identifier.

The coupon server may store the coupon availability data in a variety of forms in a data repository, such as data store 212. For example, the coupon server may add an offer identifier or unique coupon identifier to a list of coupon offers available via the coupon server account. As another example, the coupon server may add the account identifier to a list of account identifiers for which the coupon offer is available.

In an embodiment, block 320 comprises creating a digital coupon for the coupon offer. The digital coupon includes one or more unique coupon identifiers, analogous to unique coupon identifiers on printable identifiers. These one or more unique coupon identifiers are used for a variety of purposes, including tracking, fraud prevention, and/or receiving compensation from a clearinghouse. Thus, among other effects, the digital coupon may be tracked and redeemed using coupon infrastructures that already exist for printable coupons.

At block 330, a retailer receives basket data specifying one or more items for purchase in a transaction. Each item may be specified by any suitable type of item identifier, including UPC codes, model numbers, and so forth. Block 330 may be performed, for example, by a terminal at the retailer's point-of-sale. The basket data may be received at the terminal by any combination of scanning UPC codes, detecting radio frequency identifiers, customer or cashier input, or receiving input from mobile device. Alternatively or additionally, block 330 may be performed by a retail server. The retail server receives the basket data from a terminal at one of the retailer's point-of-sales, which in turn receives the basket data as described above.

At block 335, the retailer receives token data from a mobile device operated by the customer with which the retailer is transacting. While, in an embodiment, the token data is an NFC token, the token may in fact be any set of data received from the mobile device, regardless of how that data is received. In an embodiment, the token data is received via a proximity-based link, as described elsewhere in the application. The token may encapsulate any number of data elements, including various identifiers or other information related to the transaction.

At block 340, the retailer locates an identifier based on the token data received in block 335. The identifier may be contained in the token data. For example, the token data may include a coupon server account identifier, a device identifier, a user identifier, or a payment identifier. Instead, the retailer may locate the identifier based on information in the token data. For example, the retailer may locate an account identifier based on a device identifier in the token data. As another example, the retailer may locate an account identifier that is mapped to a transaction identifier in the token data.

At block 345, the retailer sends a request to the coupon server. The request comprises the identifier located in block 340.

At block 350, the coupon server uses the identifier to locate an account at the coupon server associated with the identifier. For example, the coupon server may maintain a mapping of identifiers to account data.

At block 355, assuming that an account was located in block 350, the coupon server provides digital coupon availability data to the retailer, responsive to the request of block 345. The digital coupon availability data specifies coupon offers and/or digital coupons that have been made available to the account located in block 350. In an embodiment, the coupon server tailors the digital coupon availability data to each retailer. For example, some retailers may not sell certain products, and thus information about corresponding digital coupons may be removed from the digital coupon availability data provided to those retailers. Data may also be reformatted for the retailers, and may also include data indicating terms of a coupon offer, in the event that a retailer does not already have access to those terms.

At block 360, the retailer compares the digital coupon availability data of block 355 to the basket data of block 330 to identify one or more coupon offers that may be applied to the transaction. For example, the retailer may determine that one of the coupon offers associated with the identifier is applicable to a certain product or service being purchased as part of the transaction. The retailer may do so, for instance, by comparing item identifies in the basket data to item identifiers mapped to each coupon offer described in the digital coupon availability data.

At block 365, the retailer applies the one or more coupon offers to the transaction, by adjusting the total amount to charge for each applicable item in accordance with the terms of the indentified one or more coupon offers.

At block 370, the retailer sends transaction information and at least a portion of the token data to a payment server. The portion of the token data may include payment information, such as an encrypted credit card number or a funds transfer identifier. The portion of the token data may be the same as the identifier sent to the coupon server, or the portion of the token data may be different than the identifier sent to the coupon server. The transaction information includes at least a total amount to charge a payment account corresponding to the portion of the token data.

At block 375, the payment server identifies a payment account from which to obtain funds for the transaction. For example, the payment server may identify a credit card number based on encrypted data in the token data. Or, the payment server may identify a bank account based on a phone number and personal identification number in the token data.

At block 380, the payment server sends data to the retailer authorizing the transaction. Block 380 is performed, of course, only if the identified payment account has the appropriate funds or credit for the transaction.

At block 385, the retailer concludes the transaction and optionally provides the user with a receipt. In an embodiment, the receipt is provided directly to the mobile device via a return token and/or a back-end communication with the payment server and/or coupon server.

At block 390, the retailer optionally reports coupon usage data to the coupon server. The coupon usage data indicates that the one or more applicable digital coupons have been redeemed in association with the provided account identifier.

At block 395, the retailer sends a request to a clearinghouse for compensation for applying the one or more coupon offers to the transaction. In an embodiment, block 390 and 395 are a same step.

While certain blocks of flow 300 describe actions in terms of performance by a retailer, the actions will actually be performed by a retail server, a terminal at the retailer's point-of-sale, and/or a specialized device coupled thereto, such as an NFC reader. Flow 300 illustrates but one embodiment of the techniques described herein. Other embodiments may include fewer, additional, and/or different elements in potentially varying orders. For example, in an embodiment, no portion of the token data is sent to the payment server. Rather credentials to send to the payment server are obtained via other means such as swiping a credit card, or payment is obtained without interfacing with the payment server. For instance, payment may be obtained via cash.

Other examples of other embodiments are described elsewhere in the application. In an embodiment, the coupon server is the same as the payment server. In an embodiment, the payment server locates coupon data and automatically applies coupon data to the transaction, thus avoiding the need for the retailer to communicate with the coupon server. In an embodiment, coupon offers are identified in the token data

### V. Transferring Information Via A Proximity-Based Link

Various embodiments described herein rely upon a transfer of information via a proximity-based link to initiate the coupon redemption process. For example, the coupon redemption process may begin with the customer's mobile device sending coupon identifiers or a token directly to the terminal via an NFC transmitter. In an embodiment, the transfer may occur at any time during a transaction prior to payment, including prior to and during the identification of item identifiers for purchase.

In an embodiment, the transfer occurs at least partially in response to customer input at the mobile device during the transaction. The customer may, for instance, access a coupon client interface on the mobile device and instruct the mobile device to begin the coupon redemption process. The customer may issue the instruction, for instance, by tapping on a button having labels such as “use coupons now,” “send coupons,” “redeem coupons” or similar.

Depending on the type of proximity interface involved, the mobile device may transfer the relevant information in a variety of ways upon receiving the customer input. For example, the mobile device may broadcast the relevant information a single time over a proximity interface. As another example, upon receiving the customer input, the mobile device may broadcast the relevant information over a proximity interface repeatedly until a termination event occurs. A suitable termination event may comprise, for instance, receiving an acknowledgement message from the terminal over the proximity-based link or from a coupon server via a backend link. A suitable termination event might also or instead comprise receiving customer input to cease transmission, close the coupon client interface, or place the mobile device in a standby state.

As another example, upon receiving the customer input, a coupon client component of the mobile device may register a handler with a component that monitors the state of the proximity interface. Upon detecting an active proximity-based link over the proximity interface, the component may cause the relevant information to be transferred via the proximity-based link, either directly or by issuing callback instructions to the coupon client component.

In an embodiment, an active proximity-based link may be detected in a variety of manners using a variety of protocols. For instance, the mobile device may wait to detect a “ping” message from another proximity interface, or repeatedly send out “ping” messages via the proximity interface until an acknowledgment message has been received. For example, an active proximity-based link may be detected in response to signals received over a proximity interface as a customer waves an NFC component of the phone within the proximity of an NFC component of the terminal.

In an embodiment, when a proximity-based link is activated, information about each party involved in the link is shared between the parties. Based on this information, the mobile device and/or terminal may determine whether the link has been established with a device that is equipped to participate in the coupon redemption process. The transfer of information to initiate the coupon redemption process is conditioned upon the link having been established with a suitable device. For example, the mobile device may be configured to only send coupon information when an active link has been established with device identifying itself as being of a device type that is capable of handling coupons or, more generically, electronic fund transactions.

In an embodiment, the customer need not explicitly instruct the mobile device to begin the coupon redemption process. For example, the mobile device may be configured to periodically transmit the relevant information via the proximity interface without the customer having instructed the mobile device to do so. As another example, in an embodiment, the mobile device may be configured to monitor for an active proximity-based link, similar to as described above. Activation of the proximity-based link automatically triggers the mobile device to transfer the relevant information to the terminal. In some embodiments, the transfer of information may occur upon activation of the proximity-based link automatically, without the customer having provided any input to the mobile device during the transaction.

In an embodiment, activation of the proximity-based interface may trigger a request for customer input at the mobile device. If necessary, the customer may provide this input while the proximity-based link is terminated, and then re-establish the proximity-based link to complete the transfer by, for instance, swiping the mobile device again.

In an embodiment, other customer input may be received to establish a proximity-based link. For example, the customer may enter a terminal identifier, transaction identifier, or pairing identifier in order to establish a link with a terminal in environments where the range of signals transmitted or received by a proximity interface is large enough that the terminal and/or mobile device could unintentionally form links with devices that are not part of the transaction. In such an environment, a terminal identifier, transaction identifier, Wi-Fi service set identifier, or pairing identifier may be given visually or aurally to the customer at the terminal. A connection component at the mobile device provides an interface for entering the identifier. The interface may be presented to the customer either in response to receiving an initial message via the proximity interface, or at the customer's request. The interface may be presented via, for instance, a coupon client application, a retailer web page, a proxy server-based web page, a device driver, and so on. Once the customer gives the identifier, the connection component of the mobile device causes the proximity-based link to be established by, for example, directing the mobile device to an IP address associated with the identifier. Alternatively, the connection component sends a message that embeds the identifier out over the proximity-based interface, thereby allowing the terminal to recognize that the message is specifically directed to the terminal.

In an embodiment, the coupon redemption process is initiated by the transfer of information from the terminal as opposed to from the mobile device. For example, the terminal may initiate the coupon redemption process by transferring a token or basket data to the mobile device via the proximity-based link. The terminal may be configured to transfer the relevant information using techniques similar to the techniques described with respect to the mobile device above. For example, the terminal may receive instructions from a clerk or a checkout process that cause the terminal to send the relevant information via the terminal's proximity-based link. As another example, the terminal may be configured to transmit the relevant information upon detection of an active proximity-based link. As another example, the terminal may be configured to periodically or continuously broadcast a terminal identifier via the terminal's proximity interface. As another example, the link between the terminal and mobile device may be established by the inputting of an identifier such as a phone number at the terminal.

### VI. Selecting Coupons for a Transaction

Various embodiments include a coupon selection process during which a mobile device, coupon server, and/or retail server identify a set of one or more coupons to attempt to apply to a transaction. Identification of a coupon during the selection process does not necessarily imply that the coupon is actually eligible to be used in the transaction. An eligibility determination, discussed in the next section, may instead be subsequently performed on coupons identified during the selection process.

In an embodiment, the selection process includes identifying which coupons have been saved to a customer's account or mobile device. The selection process may further involve filtering the customer's saved coupons by store, retailer, and/or time period, if known. The store and/or retailer may be determined, depending on the embodiment, using location data detected from the mobile device, input from a customer, an identifier for the terminal at which the transaction is being conducted, and/or the identity of a retail server that is requesting coupon data for a customer. The selection process may further involve comparing the customer's grocery list data, such as a list of items indicated as being in the customer's shopping cart, to the customer's coupons.

In an embodiment, prior to receiving instructions to begin the coupon redemption process, the mobile device may offer a customer an interface for further filtering the selected set of coupons. Then, upon selecting one or more coupons from the set, the customer may instruct the mobile device to begin the coupon redemption process. However, in an embodiment, the mobile device need not offer such an interface.

In an embodiment, prior to presenting an interface for selecting coupons at the mobile device, the selected coupons may further be filtered by comparing identifiers for items involved in the transaction, or even family codes thereof, to coupons that have been saved for the customer. Thus, the customer is allowed to select only from coupons that are for items that the customer is purchasing. The coupon server or mobile device may have received item identifiers, for instance, via the proximity interface and/or backend interface of the terminal. In some embodiments, the eligibility of each coupon in the selected set presented to the customer has already been determined. Therefore, further eligibility determination is not necessary after the customer selects coupons at the mobile device.

Other techniques may also or instead be used to select a set of coupons to attempt to apply to a transaction. For example, rather than select coupons that have been saved by a customer, a coupon server or mobile device may select coupons that have been selected by an advertiser, retailer, or friend. As another example, coupons may be selected based on customer preferences or historical information.

In an embodiment, prior to selecting a set of coupons to return in response to a backend query from a retail server, terminal, or payment server, the coupon server is configured to send instructions to the mobile device that cause the mobile device to display an interface for the customer to select coupons, or to otherwise filter a set of coupons, as discussed above.

Once a set of one or more coupons has been identified, identifiers for those coupons are transferred from the identifying system component(s) to another system component, if necessary, for coupon eligibility determination.

### VII. Determining Coupon Eligibility for a Transaction

Various embodiments involve a determination of whether a particular coupon may be applied to a particular transaction. Any of the entities involved in the transaction may make the determination, assuming the entity has sufficient information about the particular coupon and the particular transaction. A variety of techniques are possible for making this determination, examples of which are described below.

According to an embodiment, a set of item identifiers for a transaction, and optionally corresponding quantities, are scanned or otherwise input at a terminal. The terminal, retail server, or any other suitable system component then generates “basket data” for the transaction, comprising the set of item identifiers and, optionally, other information about the transaction, such as quantities and prices involved in a transaction.

Meanwhile, one or more coupon identifiers corresponding to the one or more coupons selected via the selection process described above are received at a suitable system component. The one or more coupon identifiers may be received with eligibility criteria for each coupon identifier, such as item identifier(s) that may or must appear in the transaction, quantities of items that must be purchased, price restrictions, limitations on the number of coupons per transaction, and so forth. Alternatively, each coupon identifier may be used to look up eligibility criteria, either by directly querying a coupon server, or by querying an intermediate database at which such criteria has been cached. In an embodiment, a coupon offer identifier is received with or may be determined from a coupon identifier. The coupon offer identifier may then be used to perform the eligibility criteria lookup operation.

Any system component that has both the basket data and the eligibility criteria may then proceed to determine whether any given coupon may be applied against the transaction. The exact component responsible for this determination varies depending on the embodiment. The coupon eligibility determination may occur, without limitation, at any of the terminal, retail server, coupon server, mobile device, and payment server. If either of the basket data or eligibility criteria is not already available to the component responsible for eligibility determination, the basket data and/or the eligibility criteria may be forwarded to the component.

Determining the eligibility of a given coupon for a particular transaction is relatively straightforward once the appropriate basket data and eligibility criteria are known. The eligibility determination process may include, for example, comparing item identifiers in the basket data to item identifiers in the eligibility criteria for a given coupon identifier. Any suitable eligibility determination process may be employed.

Once the eligible coupon identifiers are known, in an embodiment, the component responsible for determining coupon eligibility may then apply appropriate offer(s) to the transaction, as indicated by offer terms associated with each eligible coupon identifier. Offer terms may indicate, for example, a discount to apply to the transaction, a special price to apply to an item, or an additional item to provide to the customer. For example, once the terminal has identified that a first coupon is eligible for use in a transaction, the terminal may deduct an appropriate discount amount for the first coupon from the total amount of the transaction. If the offer corresponding to a given coupon identifier is not already known, the coupon discount may be obtained in a manner similar to the eligibility criteria lookup operation. In an embodiment, rather than apply coupons to the transaction, the component responsible for determining coupon eligibility may identify the eligible coupon identifiers to another system component.

VIII. Coupon Redemption Initiated by Direct Transfer of Coupon Data from Mobile Device

### Coupon Eligibility Determined at Terminal

In an embodiment, a set of one or more coupons are selected at the mobile device, with possible assistance from the coupon server via backend communications. During a transaction, the mobile device transfers coupon identifiers, eligibility criteria, and offer terms for each coupon in the set of one or more coupons to the terminal via a proximity-based link. The terminal determines whether each coupon in the set of coupons is eligible for use in the transaction based on basket data generated at the terminal. Each coupon that is eligible for use in the transaction is applied against the transaction based on the offer terms. The terminal then prompts the customer for payment.

In an embodiment, a set of one or more coupons are selected at the mobile device, with possible assistance from the coupon server via backend communications. During a transaction, the mobile device transfers coupon identifiers for each coupon in the set of one or more coupons to the terminal via a proximity-based link. The terminal queries a retail server or coupon server to obtain appropriate eligibility criteria and offer terms for each coupon identifier in the set. The terminal then determines whether each coupon in the set of coupons is eligible for use in the transaction based on basket data generated at the terminal. Each coupon that is eligible for use in the transaction is applied against the transaction based on the offer terms. The terminal then prompts the customer for payment.

### Coupon Eligibility Determined at Retail or Coupon Server

In an embodiment, a set of one or more coupons are selected at the mobile device, with possible assistance from the coupon server via backend communications. During a transaction, the mobile device transfers coupon identifiers for each coupon in the set of one or more coupons to the terminal via a proximity-based link. The terminal sends item identifiers and, if necessary, other basket data along with the coupon identifiers to a coupon server or a retail server. The coupon server or retail server identifies eligibility criteria and offer terms for each coupon identifier in the set, if necessary. The coupon server or retail server then determines whether each coupon in the set of coupons is eligible for use in the transaction based on basket data generated at the terminal. The coupon server or retail server then identifies each eligible coupon in the set to the terminal. The coupon server or retail server also sends information about each eligible offer to the terminal, either with the identification of eligible coupons, or in response to additional queries from the terminal. The terminal then applies each coupon that is eligible for use in the transaction against the transaction. The terminal then prompts the customer for payment.

In an embodiment, a set of one or more coupons are selected at the mobile device, with possible assistance from the coupon server via backend communications. During a transaction, the mobile device transfers coupon identifiers for each coupon in the set of one or more coupons to the terminal via a proximity-based link. The terminal sends item identifiers and, if necessary, other basket data along with the coupon identifiers to a retail server. The retail server locates appropriate eligibility criteria and offer terms for each coupon identifier in the set. The retail server may locate the eligibility criteria and offer terms at least partially in a database at the retail server. The retail server may also or instead query a coupon server for eligibility criteria and offer terms. The retail server then determines whether each coupon in the set of coupons is eligible for use in the transaction based on the basket data. The retail server then applies each coupon that is eligible for use in the transaction against the transaction. The retail server returns updated basket data to the terminal, with the eligible coupons applied. The terminal then prompts the customer for payment.

### Coupon Eligibility Determined at Payment Server

In an embodiment, a set of one or more coupons are selected at the mobile device, with possible assistance from the coupon server via backend communications. During a transaction, the mobile device transfers coupon identifiers for each coupon in the set of one or more coupons to the terminal via a proximity-based link. The terminal prompts the customer for payment information. The terminal, with possible assistance from the retail server, sends basket data, payment information, and coupon identifiers to a payment server. The payment server queries a coupon server for eligibility criteria and offer terms for each coupon identifier in the set, if the information is not already known to the payment server. The payment server then determines whether each coupon in the set of coupons is eligible for use in the transaction based on the basket data. The payment server then identifies each eligible coupon in the set. The payment server then applies each coupon that is eligible for use in the transaction against the transaction. The payment server returns a transaction record to the terminal, indicating whether the transaction was successful and, optionally, which coupons were applied.

### Validating Coupons

In an embodiment, the mobile device encrypts coupon identifiers using a secure and trusted algorithm prior to sending the coupon identifiers. Any component of the coupon redemption system may ensure that the coupon identifiers are authentic by checking to make sure that the coupon identifiers are in fact encrypted using this trusted algorithm. Moreover, in an embodiment, a terminal or retail server notifies the coupon server and, by extension, the mobile device when saved coupons are redeemed. The mobile device is configured to not attempt to send redeemed coupons in future transactions. Thus, any coupon identifiers sent by the mobile device are guaranteed to be valid.

In an embodiment, the terminal queries the coupon server or retail server (if coupon account data is cached at the retail server), or the retail server queries the coupon server, to determine if a given coupon is authentic and still valid. In an embodiment, the coupon server is configured to include indications of authenticity and validity when responding to requests for eligibility criteria or other offer terms for a specific coupon identifier.

### IX. Coupon Redemption Initiated by Token Transfer

A. Token Originating from Mobile Device

In an embodiment, the coupon redemption process is initiated by a transfer of a token from the mobile device to the terminal. The token may include, for instance, a customer identifier, customer account identifier, mobile device identifier, and/or proximity interface identifier. The customer may have registered the various identifiers in the token as being associated with the customer's account. The registration may be stored with any or all of the retailer, coupon provider, or payment provider.

For some token types, the mobile device may be configured to automatically transmit the token whenever a proximity-based link is activated, without regard to the context of the link. For other token types, the mobile device may only transmit the token in response certain conditions being met, such as the mobile device having received customer input requesting to begin the coupon redemption process, or the interface at the other end of the link identifying itself as having certain characteristics.

### Coupon Eligibility Determined at Terminal

In an embodiment, during a transaction, the mobile device transfers the token to the terminal via the proximity-based link. The terminal uses the token to query a retail server or coupon server. The retail server or coupon server uses the token to locate account information for the customer. The retail server or coupon server selects a set of one or more coupons for the customer based on the customer's account information. The retail server or coupon server responds to the query by returning identifiers for the selected coupons to the terminal. The terminal may further issue additional queries to the retail server or the coupon server to obtain eligibility criteria and offer terms for the identifiers, if the terminal has not already received such information. The terminal then determines which coupons in the set of coupons are eligible for use in the transaction. The terminal furthermore applies the eligible coupons to the transaction. The terminal then prompts the customer for payment.

### Coupon Eligibility Determined at Retail or Coupon Server

In an embodiment, during a transaction, the mobile device transfers the token to the terminal via the proximity-based link. The terminal sends item identifiers and, if necessary, other basket data along with the token to a coupon server or a retail server. The retail server or coupon server uses the token to locate account information for the customer. The retail server or coupon server selects a set of one or more coupons for the customer based on the customer's account information. The coupon server or retail server identifies eligibility criteria and offer terms for each coupon in the set. The coupon server or retail server then determines whether each coupon in the set of coupons is eligible for use in the transaction based on the basket data generated at the terminal. The coupon server or retail server then identifies each eligible coupon in the set to the terminal. The coupon server or retail server also sends offer information for each eligible coupon to the terminal, either with the identification of eligible coupons, or in response to additional queries from the terminal. The terminal then applies each coupon that is eligible for use in the transaction against the transaction. The terminal then prompts the customer for payment.

In an embodiment, during a transaction, the mobile device transfers the token to the terminal via the proximity-based link. The terminal sends item identifiers and, if necessary, other basket data along with the token to a retail server. The retail server uses the token to identify a set of one or more coupons for the customer. The set of coupons may be selected with or without assistance from the coupon server. For example, the retail server may use the token to locate the customer's account information in a database at the retail server, and then select the set of coupons based on the account information. As another example, the retail server may use the token to query the coupon server for a set of coupons. The coupon server then uses the token to locate customer account information and select a set of coupons based thereon. The retail server further locates appropriate eligibility criteria and offer terms for each coupon identifier in the set. Again, the retail server may locate the eligibility criteria and offer terms at least partially in a database at the retail server, or the retail server may also or instead query a coupon server for eligibility criteria and offer terms. The retail server then determines whether each coupon in the set of coupons is eligible for use in the transaction based on the basket data. The retail server then applies each coupon that is eligible for use in the transaction against the transaction. The retail server returns updated basket data to the terminal, with the eligible coupons applied. The terminal then prompts the customer for payment.

In an embodiment, during a transaction, the mobile device transfers the token to the terminal via the proximity-based link. The terminal sends item identifiers and, if necessary, other basket data along with the token to a coupon server. Depending on the embodiment, the information may be relayed to the coupon server via the retail server. The coupon server then uses the token to locate customer account information and select a set of coupons based thereon. The coupon server further locates eligibility criteria and offer terms for each coupon identifier in the set. The coupon server then determines whether each coupon in the set of coupons is eligible for use in the transaction based on the basket data. The coupon server then identifies each eligible coupon in the set to the terminal or retail server. The terminal or retail server then applies each coupon that is eligible for use in the transaction against the transaction. If the retail server is applying coupons to the transaction, the retail server further returns updated basket data to the terminal, with the eligible coupons applied. The terminal then prompts the customer for payment.

### Coupon Eligibility Determined at Payment Server

In an embodiment, during a transaction, the mobile device transfers a token to the terminal via the proximity-based link. The terminal prompts the customer for payment information. The terminal, with possible assistance from the retail server, sends basket data, payment information, and the token to a payment server. The payment server uses the token to identify a set of one or more coupons for the customer. The set of coupons may be selected with or without assistance from the coupon server. For example, the payment server may use the token to locate the customer's account information in a database at the payment server, and then select the set of coupons based on the account information. As another example, the payment server may use the token to query the coupon server for a set of coupons. The coupon server then uses the token to locate customer account information and select a set of coupons based thereon. The payment server further locates eligibility criteria and offer terms for each coupon identifier in the set. Again, the payment server may locate the eligibility criteria and offer terms at least partially in a database at the payment server, or the payment server may also or instead query a coupon server for eligibility criteria and offer terms. The payment server then determines whether each coupon in the set of coupons is eligible for use in the transaction based on the basket data. The payment server then identifies each eligible coupon in the set. The payment server then applies each coupon that is eligible for use in the transaction against the transaction, based on the offer terms. The payment server returns a transaction log to the terminal, indicating whether the transaction was successful and, optionally, which eligible coupons were applied.

B. Token Originating from Terminal

In an embodiment, the coupon redemption process is initiated by the transfer of a token from the terminal to the mobile device. The token may include, for instance, a terminal identifier, retailer identifier, and/or transaction identifier. The retailer may have registered various identifiers in the token as being associated with the terminal or the retail server. The registration may be stored at either or both of the coupon provider and the payment provider.

### Coupon Eligibility Determined at Terminal

In an embodiment, during a transaction, the terminal transfers the token to the mobile device via the proximity-based link. The mobile device forwards the token to a coupon server, along with an identifier for the mobile device and/or the customer. The coupon server uses the identifier for the mobile device or customer to locate account information for the customer. The coupon server selects a set of one or more coupons for the customer based on the customer's account information. The coupon server uses the token to identify the terminal or a retail server for the terminal. The coupon server sends identifiers for the selected coupons to the terminal, possibly via the retail server. The terminal may further issue additional queries to the retail server or the coupon server to obtain eligibility criteria and offer terms for the identifiers, if the terminal has not already received such information. The terminal then determines which coupons in the set of coupons are eligible for use in the transaction. The terminal furthermore applies the eligible coupons to the transaction, in accordance with the offer terms. The terminal then prompts the customer for payment.

### Coupon Eligibility Determined at Retail Server

In an embodiment, during a transaction, the terminal transfers the token to the mobile device via the proximity-based link. The mobile device forwards the token to a coupon server, along with an identifier for the mobile device and/or the customer. The coupon server uses the identifier for the mobile device or customer to locate account information for the customer. The coupon server selects a set of one or more coupons for the customer based on the customer's account information. The coupon server uses the token to identify a retail server. The coupon server sends identifiers for the selected coupons and the token to the retail server. The retail server may issue additional queries to the coupon server to obtain eligibility criteria and offer terms for the identifiers, if necessary. The retail server uses the token to locate or request basket data for a transaction indicated by the token. For instance, the token may be a transaction identifier. The terminal may have sent the transaction identifier to the retail server along with basket data associated with the transaction. As another example, the token may be a terminal identifier. The retail server may locate the terminal based on the terminal identifier, and query the terminal for basket data for the current transaction. Alternatively, the retail server may have already received the basket data with an indication that the basket data is for a current transaction at the terminal having the terminal identifier. Regardless of how the basket data is received or located, the retail server then determines which coupons in the set of coupons are eligible for use in the transaction. From this point, the retail server may apply the eligible coupons to the transaction and send updated basket data to the terminal, or the retail server may identify the eligible coupons to the terminal and the terminal may apply the eligible coupons to the transaction. The terminal then prompts the customer for payment.

In an embodiment, during a transaction, the terminal transfers the token to the mobile device via the proximity-based link. The mobile device sends the token directly to the retail server via, for instance, a local wireless network or a mobile shopping application provided by the retailer. The mobile device further communicates a customer identifier or a set of coupons identified for the customer directly to the retail server. The retail server then proceeds with the coupon redemption process using any of the various techniques described herein. For example, the retail server may determine coupon eligibility itself, or the retail server may provide any other system component, including the mobile client, payment server, or coupon server, with information to facilitate a coupon eligibility determination at that component.

### Coupon Eligibility Determined at Coupon Server

In an embodiment, during a transaction, the terminal transfers the token to the mobile device via the proximity-based link. The mobile device forwards the token to a coupon server, along with an identifier for the mobile device and/or the customer. The coupon server uses the identifier for the mobile device or customer to locate account information for the customer. The coupon server selects a set of one or more coupons for the customer based on the customer's account information. The coupon server uses the token to identify a transaction indicated by the token. For instance, the token may be a transaction identifier. The terminal or retail server may have sent the transaction identifier to the coupon server along with basket data associated with the transaction. As another example, the token may be a terminal identifier. The coupon server may locate the terminal or a retail server based on the terminal identifier, and query the terminal or retail server for basket data for the current transaction. Alternatively, the coupon server may have received the basket data from the terminal or retail server with an indication that the basket data is for a current transaction at the terminal having the terminal identifier. Regardless of how the basket data is received or located, the coupon server then determines whether each coupon in the set of coupons is eligible for use in the transaction based on the basket data. The coupon server then identifies the location of a retail server or terminal based on the token, if the coupon server has not already done so. The coupon server identifies each eligible coupon in the set to the terminal or retail server. The terminal or retail server then applies each coupon that is eligible for use in the transaction against the transaction. If the retail server is applying coupons to the transaction, the retail server further returns updated basket data to the terminal, with the eligible coupons applied. The terminal then prompts the customer for payment.

In an embodiment, during a transaction, the terminal transfers the token to the mobile device via the proximity-based link. The mobile device forwards the token to a coupon server, along with an identifier for the mobile device and/or the customer. The coupon server uses the identifier for the mobile device or customer to locate account information for the customer. The coupon server selects a set of one or more coupons for the customer based on the customer's account information. Meanwhile, basket data for the transaction is sent with payment information for the transaction to the payment server. The payment server shares this data with the coupon server, so that the coupon server can use the token to identify the transaction and locate the basket data. For example, the payment server may have proactively sent a transaction identifier to the coupon server along with basket data associated with the transaction. The coupon server may use the token to locate the transaction identifier and associated basket data. Alternatively, the coupon server may query the payment server using the token (or portion thereof), and receive the basket data for the transaction in return. Regardless of how the basket data is received or located, the coupon server then determines whether each coupon in the set of coupons is eligible for use in the transaction based on the basket data. The coupon server identifies each eligible coupon in the set to the payment server. The payment server then applies each coupon that is eligible for use in the transaction against the transaction. The payment server may issue additional queries to the coupon server to obtain offer terms for the coupons, if necessary. The payment server returns a transaction record to the terminal, indicating whether the transaction was successful and, optionally, which eligible coupons were applied.

### Coupon Eligibility Determined at Mobile Device

In an embodiment, during a transaction, the terminal transfers the token to the mobile device via the proximity-based link. The mobile device, with possible assistance from the coupon server and/or customer, selects a set of one or more coupons for the customer. The mobile device furthermore forwards the token to a coupon server, along with an identifier for the mobile device. The coupon server uses the token to identify a transaction indicated by the token. For instance, the token may be a transaction identifier. The terminal or retail server may have sent the transaction identifier to the coupon server along with basket data associated with the transaction. As another example, the token may be a terminal identifier. The coupon server may locate the terminal or a retail server based on the terminal identifier, and query the terminal or retail server for basket data for the current transaction. Alternatively, the terminal may have already sent basket data to the coupon server with an indication that the basket data is for a current transaction. Regardless of how the basket data is received or located, the coupon server then forwards the basket data to the mobile device. The mobile device determines whether each coupon in the set of coupons is eligible for use in the transaction based on the basket data. The mobile device identifies eligible coupons to the coupon server. The coupon server then identifies the location of a retail server or terminal based on the token, if the coupon server has not already done so. The coupon server identifies each eligible coupon in the set to the terminal or retail server. The terminal or retail server then applies each coupon that is eligible for use in the transaction against the transaction. The retail server or terminal may issue additional queries to the coupon server to obtain offer terms for the identifiers, if necessary. If the retail server is applying coupons to the transaction, the retail server further returns updated basket data to the terminal, with the eligible coupons applied. The terminal then prompts the customer for payment.

In an embodiment, during a transaction, the terminal transfers the token to the mobile device via the proximity-based link. The mobile device, possibly assisted by the coupon server and/or the customer, selects a set of one or more coupons for the customer. Meanwhile, basket data for the transaction and payment information are sent to the payment server. The mobile device queries the payment server using the token, and receives the basket data for the transaction in return. The mobile device then determines whether each coupon in the set of coupons is eligible for use in the transaction based on the basket data. The mobile device identifies each eligible coupon in the set to the payment server. The payment server then applies each coupon that is eligible for use in the transaction to the transaction. The payment server may issue additional queries to the coupon server to obtain offer terms for the identifiers, if necessary. The payment server returns a transaction record to the terminal, indicating whether the transaction was successful and, optionally, which eligible coupons were applied.

### Coupon Eligibility Determined at Payment Server

In an embodiment, during a transaction, the terminal transfers the token to the mobile device via the proximity-based link. The mobile device forwards the token to a coupon server, along with an identifier for the mobile device and/or the customer. The coupon server uses the identifier for the mobile device or customer to locate account information for the customer. The coupon server selects a set of one or more coupons for the customer based on the customer's account information. The coupon server sends the set of coupons along with the token to a payment server. The payment server uses the token to identify a transaction indicated by the token. The transaction is a transaction for which the payment server is currently receiving payment. For instance, the token may be a transaction identifier. The terminal or retail server may have sent the transaction identifier to the payment server along with basket data associated with the transaction. The transaction identifier and basket data may have been sent as part of a request to transfer funds to the retailer from a payment source indicated by the customer. As another example, the token may be a terminal identifier. The payment server may locate the terminal or a corresponding retail server based on the terminal identifier. The payment server may then query the terminal or retail server for basket data and payment data for the transaction currently being conducted at the terminal having the terminal identifier. Alternatively, a retail server may have already sent basket data to the payment server in a funds transfer request, with an indication that the basket data is for a current transaction at the identified terminal. Regardless of how the basket data is received or located, the payment server then determines whether each coupon in the set of coupons is eligible for use in the transaction based on the basket data. The payment server may issue additional queries to the coupon server to obtain eligibility criteria and offer terms for the identifiers, if necessary. The payment server then applies each coupon that is eligible for use in the transaction against the transaction. The payment server returns a transaction record to the terminal, indicating whether the transaction was successful and, optionally, which eligible coupons were applied.

In an embodiment, during a transaction, the terminal transfers the token to the mobile device via the proximity-based link. The mobile device selects a set of one or more coupons for the customer. Optionally, the selecting is assisted by the coupon server and/or customer input. The mobile device forwards the token to a payment server along with the selected set of coupons. The payment server uses the token to identify a transaction indicated by the token. The transaction is a transaction for which the payment server is currently receiving payment. For instance, the token may be a transaction identifier. The terminal or retail server may have sent the transaction identifier to the payment server along with basket data associated with the transaction. The transaction identifier and basket data may have been sent as part of a request to transfer funds to the retailer from a payment source indicated by the customer. As another example, the token may be a terminal identifier. The payment server may locate the terminal or a corresponding retail server based on the terminal identifier. The payment server may then query the terminal or retail server for basket data and payment data for the transaction currently being conducted at the terminal having the terminal identifier. Alternatively, a retail server may have already sent basket data to the payment server in a funds transfer request, with an indication that the basket data is for a current transaction at the identified terminal. Regardless of how the basket data is received or located, the payment server then determines whether each coupon in the set of coupons is eligible for use in the transaction based on the basket data. The payment server may issue additional queries to the coupon server or mobile device to obtain eligibility criteria and offer terms for the identifiers, if necessary. The payment server then applies each coupon that is eligible for use in the transaction against the transaction. The payment server returns a transaction record to the terminal, indicating whether the transaction was successful and, optionally, which eligible coupons were applied.

In an embodiment, during a transaction, the terminal transfers the token to the mobile device via the proximity-based link. The mobile device forwards the token and a customer or mobile device identifier to a payment server. The payment server uses the customer or mobile device identifier to identify a set of one or more coupons for the customer. The set of coupons may be selected with or without assistance from the coupon server. For example, the payment server may use the customer or mobile device identifier to locate the customer's account information in a database at the payment server, and then select the set of coupons based on the account information. As another example, the payment server may use the customer or mobile device identifier to query the coupon server for a set of coupons. The coupon server then uses the customer or mobile device identifier to locate customer account information and select a set of coupons based thereon. The payment server further locates eligibility criteria and offer terms for each coupon identifier in the set. Again, the payment server may locate the eligibility criteria and offer terms at least partially in a database at the payment server, or the payment server may also or instead query a coupon server for eligibility criteria and offer terms. The payment server uses the token to identify a transaction indicated by the token. The transaction is a transaction for which the payment server is currently receiving payment. For instance, the token may be a transaction identifier. The terminal or retail server may have sent the transaction identifier to the payment server along with basket data associated with the transaction. The transaction identifier and basket data may have been sent as part of a request to transfer funds to the retailer from a payment source indicated by the customer. As another example, the token may be a terminal identifier. The payment server may locate the terminal or a corresponding retail server based on the terminal identifier. The payment server may then query the terminal or retail server for basket data and payment data for the transaction currently being conducted at the terminal having the terminal identifier. Alternatively, a retail server may have already sent basket data to the payment server in a funds transfer request, with an indication that the basket data is for a current transaction at the identified terminal. Regardless of how the basket data is received or located, the payment server then determines whether each coupon in the set of coupons is eligible for use in the transaction based on the basket data. The payment server then applies each coupon that is eligible for use in the transaction against the transaction. The payment server returns a transaction record to the terminal, indicating whether the transaction was successful and, optionally, which eligible coupons were applied.

### X. Sending Basket Data Via the Proximity-Based Link

In some embodiments, rather than communicate basket data via a backend network, the terminal sends basket data to the mobile device via the proximity-based link. The mobile device may use the basket data to select a set of coupons or identify coupons that are eligible for use in the transaction. The mobile device may also or instead forward the bucket data to the coupon server and/or the payment server, along with a token from the terminal. The coupon server and payment server may then make use of the bucket data as if the coupon server and payment server had received it via a backend network.

### XI. Paying for the Transaction

In an embodiment, once the coupons have been applied by the terminal or retail server, the terminal prompts the customer to provide payment. The customer may provide payment for the transaction, minus any applicable coupon discounts, using any suitable technique, including payment of cash, check, debit card, or credit card. In case of debit card or credit card, the terminal may submit payment information, such as the total of the transaction and a credit card number, to a payment server. The payment server verifies whether the funds are available and, if so, transfers the funds to the retailer. The payment server then indicates to the terminal or retail server whether payment was successful.

In an embodiment, the customer may utilize the mobile device to provide payment. For example, a token transferred by the mobile device to the terminal may also be linked to an electronic payment source. The terminal or a retail server may use the token to locate a payment source, or the terminal or retail server may forward the token to the payment provider so that the payment provider can locate the payment source. As another example, the mobile device may transfer two different tokens to the terminal for coupon redemption and payment, respectively. The two different tokens may be sent via the same link at the same time, the same link at a different time, or an altogether different link.

As yet another example, the mobile device may utilize a token transferred from the terminal to effect payment. For example, the token may be a transaction identifier, and/or may include basket data. The mobile device may relay the token and/or basket data to the payment server. In an embodiment, the mobile device may send the token to the payment server along with coupon data, or at least with a customer or client identifier that the payment server may use to request coupons that are associated with the customer's account.

In an embodiment, the mobile device provides a mobile payment interface by which the customer may instruct the mobile device to send a token to the terminal to facilitate payment. In an embodiment, in response to receiving a token from the terminal, the mobile device may launch a payment interface by which the token is communicated to the payment server. The interface may request the customer to verify that the customer wishes to pay the funds. In either embodiment, the payment interface may be part of the same interface as any coupon interface that is presented to the user. Alternatively, the customer may access the payment interface separately from any coupon interface.

### XII. Digital Clearing

In an embodiment, when a coupon is applied to a transaction, the system component responsible for applying the coupon to the transaction, or the system component responsible for determining that the coupon is eligible for use in the transaction, notifies the coupon server and/or mobile device that the coupon has been used. The coupon may then be removed from the customer's account, if appropriate for the terms of the coupon offer.

In an embodiment, upon completion of the transaction, the system component responsible for applying the coupon to the transaction records transaction details, including basket data and coupon identifiers that were applied to the transaction. The records may then be submitted electronically to a clearinghouse using techniques such as described in the above-referenced patent applications.

In some embodiments, the coupon server includes a clearinghouse component. In embodiments where the coupon server was responsible for determining coupon eligibility, the coupon server may simplify the clearing process by retaining basket data, transaction identifiers, and eligible coupon identifiers. The retail server or terminal may then cause a redeemed coupon to be submitted for compensation by sending an indication to the coupon server that the transaction having the retained transaction identifier was completed successfully.

### XIII. Example System Implementation

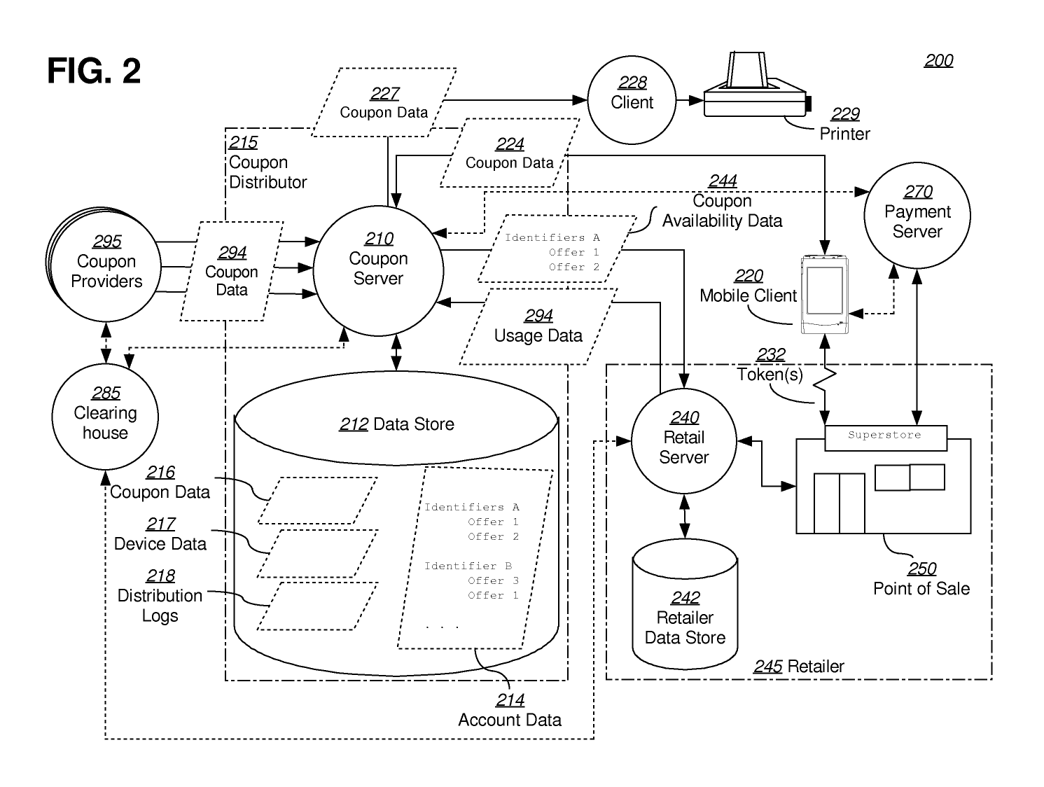

FIG. 2 is a block diagram illustrating an example system 200 in which the techniques described herein may be practiced, according to an embodiment. System 200 comprises a coupon server 210 operated by a coupon distributor 215. The coupon server 210 features a distribution component by which coupon server 210 makes coupon offers available to users, such as the operator of mobile client 220, on behalf of one or more coupon providers 295. Coupon server 210 distributes printable coupons for various offers directly to users via clients, such as client 228 coupled to a printer 229 at which the printable coupons may be printed. Coupon server 210 also makes digital coupons for various offers available to users by saving information identifying the digital coupons that have been requested by each user to one or more accounts associated with the user. The user may then provide a retailer 245 with an identifier for the account, such as a store loyalty account or user name, so that retailer 245 may retrieve any applicable digital coupons during a transaction. Or, the user may utilize digital coupons by causing a mobile client 220 to provide a token 232 over a proximity-based link, as described herein. Coupon server 210 also makes digital coupons available to users indirectly, via retailer 245 or payment server 270. For example, in response to a retail server 240, operated by retailer 245, requesting a digital coupon on behalf of a customer, coupon server 210 generates a digital coupon and provides retail server 240 with information about the generated coupon.

In an embodiment, coupon server 210 optionally includes a clearinghouse component, by which coupon distributor 215 compensates retailer 245 for accepting coupons distributed by coupon server 210. For some coupons, coupon server 210 acts as an agent of other clearinghouse 285. However, for other coupons, coupon server 210 provides compensation directly, acting as a standalone clearinghouse. Unlike conventional clearinghouses, in the embodiment, coupon server 210 both distributes coupons to users and compensates retailer 245 for accepting coupons for the same users. This unique configuration allows coupon providers 295, retailer 245, and the user to utilize coupons more efficiently with less risk of fraud, because the clearinghouse component of coupon server 210 is able to verify both the uniqueness and the authenticity of a digital coupon.

In one embodiment, coupon server 210 is a special-purpose computer configured with logic that can perform the operations described herein during operation. In an embodiment, coupon server 210 is a general-purpose computer that comprises one or more processors, and memory, mass storage device, or other non-transitory computer-readable storage media storing instructions which, when loaded and executed, cause the one or more processors to perform the operations that are further described herein.

### Coupon Provider/Distributor

In an embodiment, coupon distributor 215 is any entity capable of distributing coupons on behalf of a coupon provider 295, such as a manufacturer, retailer, or advertiser. For the purposes of this disclosure, distributing a coupon may refer to either or both of generating a coupon and saving a coupon offer to an account in association with one or more account identifiers. In this context, generating a coupon may include printing a coupon or creating and storing digital data representing a digital coupon.

A coupon provider 295 may contract with coupon distributor 215 to distribute coupons as part of a coupon campaign. The coupon provider 295 supplies coupon distributor 215 with coupon distribution data describing the coupon offer(s), as well as parameters for each coupon campaign, such as a target number of coupons to distribute in aggregate, how many coupons may be supplied to each individual end user or device, regional distribution limits, a clearinghouse to use for the campaign, and/or start and end dates for distribution. In an embodiment, coupon distributor 215 makes some or all of the same coupon offers available to multiple retailers 245 on behalf of multiple coupon providers 295, at least some of which coupon providers 295 are not retailers 245.

Coupon providers 295 may transmit coupon distribution data to coupon distributor 215 electronically via a network connecting coupon provider 295 to coupon server 210. For example, coupon server 210 may feature a web application, file sharing, or database access component by which providers 295 may upload coupon distribution data directly to coupon server 210 or coupon data store 212. Additionally or alternatively, coupon providers 295 may transmit coupon distribution data to coupon distributor 215 by any other suitable means, including orally over a telephone or via an email.

### Coupon Server

Coupon server 210 is operated by a coupon distributor 215 for, among other purposes, making coupons available to users. In an embodiment, a server may refer to one or more applications executing on one or more computers or devices that interact with counterpart client applications executing on other computers or devices. Thus, coupon server 210 may be one or more server applications, executing at one or more computing devices operated by coupon distributor 215. The coupon distribution component and clearinghouse component, if included, may each comprise entirely separate computing devices accessible via different addresses and/or networks, or the coupon distribution component and the clearinghouse component, if included, may be logically separated processes that share some or all computing and application resources.

In an embodiment, via the distribution component, coupon server 210 facilitates the availability of user-selected coupon offers in transactions with retailer 245 without requiring a customer to actually present a physical coupon. Rather, coupon server 210 saves information about one or more digital coupons to an account associated with the customer. The digital coupons may be retrieved and redeemed during a transaction by means of the user providing an identifier in place of a coupon when engaging in a transaction with retailer 245, and/or by communicating token(s) 232 over a proximity-based link as described herein. The coupon server 210 communicates relevant coupon information and identifiers to retail server 240 to facilitate this functionality.

In an embodiment, coupon server 210 distributes coupons directly to retailer 245. For instance, a retail server 240 may send a request to coupon server 210 to generate a digital coupon for the user. The coupon server 210 may respond by sending an identifier for a unique digital coupon to the retail server 240. In an embodiment, the retailer 245 may then apply the digital coupon directly to a current transaction, without providing the coupon identifier to the user or saving the identifier to the user's account. In an embodiment, coupon server 210 provides retail server 240 with logic and coupon data that collectively allow retail server 240 to generate coupons directly, such as the logic and coupon data that are described in U.S. application Ser. No. 22/821,095, filed Jun. 22, 2010, the entire contents of which are hereby incorporated by reference for all purposes as if fully set forth herein.

In an embodiment, coupon server 210 is further configured for distributing printable coupons to, among other clients, client 228. However, coupon server 210 need not necessarily be capable of distributing coupons via any particular technique described herein.

Coupon server 210 receives and responds to coupon-related requests from client 220 and/or client 228 over one or more networks, such as the Internet. Coupon server 210 retrieves coupon data 216 from data store 212 to respond to various requests from client 220/228. For example, client 220/228 may request coupon server 210 to provide a listing of available coupons, search for a coupon based on keywords, or save a digital coupon to an account for the user. In response, coupon server 210 may retrieve any relevant coupon data from data store 212, process the coupon data as appropriate, and, based on that processing, formulate a response to the client.

Coupon server 210 may be configured to control coupon distribution in a number of ways. For example, coupon server 210 may be configured to deny a client permission to print the coupon, in accordance with device-based, client-based, or aggregate distribution limits. As another example, coupon server 210 may be configured to deny a request to generate a coupon for a user if an equivalent coupon has already been generated from client 220/228. Coupon server 210 may further be configured to deny a client permission to print a coupon based on geographic information associated with the client.

Coupon server 210 may use distribution logs 218 for sending distribution reports to coupon providers 295. The form of a distribution report may vary, and may include at least data indicating either a total number of coupons that have been distributed for a particular campaign or a total number of coupons that have been distributed for the particular campaign since the last distribution report. Distribution reports may be sent at varying frequencies, and in some embodiments a report may be sent each time a particular coupon is printed. Distribution reports may further include information harvested from device data made known to coupon server, such as geographic information or client types of the devices to which coupons have been distributed.

Via the optional clearinghouse component, coupon server 210 may receive compensation requests from retail server 240. Each compensation request reports coupons that have been redeemed by retailer 245 over a certain period of time. For example, compensation requests may report coupons that were redeemed in a daily or weekly time period, since the last compensation request, or during another interval. Coupon server 210 compares coupon identifiers in the compensation requests to coupon identifiers that have been distributed by approved sources, as well as to previous compensation logs. The clearinghouse component may then provide compensation to retailer 245 by transferring appropriate compensation from provider(s) 295 of the redeemed coupon(s) to retailer 245. For instance, the clearinghouse component may debit an account for a provider 295 of a redeemed coupon and similarly credit an account belonging to retailer 245.

### Data Store

Coupon distributor 215 maintains the data supplied by coupon providers 295 as coupon data 216 in data store 212, which is coupled to coupon server 210, and can also be accessed by the optional clearinghouse component. Data store 212 may comprise one or more databases and/or file repositories. The coupon data 216 may take a variety of forms, including database records and/or one or more files. Among other aspects, coupon data 216 may comprise, for each coupon offer, data such as the name of the coupon provider 295 making the coupon offer, distribution parameters, terms of the coupon offer, print layout information and graphics, one or more internal or provider identification numbers, bar code generation information, one or more relevant uniform resource locators (URLs), one or more coupon names or titles, one or more related search terms, clearinghouse information, and one or more related categories. Distribution parameters may include aggregate distribution limit values, per device distribution limit values, per region distribution limit values, and/or per client distribution limit values.

Data store 212 further stores account data 214. The account data 214 includes data for one or more different accounts, each of which may or may not be mapped to a unique user. For example, some users may in fact have multiple accounts, while some accounts may be utilized by multiple users, such as multiple users in a family. Some or all of the accounts may have been established during a registration process with coupon distributor 210. Some or all of the accounts may instead have been established with a retailer 245, e.g. during an online or in-store registration process, and the details thereof may have been subsequently communicated by the retailer 245 to coupon distributor 210. Each account may or may not be mapped to particular identifiers and/or token data registered to the account.

Regardless of how the accounts came into existence, the account data 214 specifies one or more account identifiers for each account. Each account identifier may in turn be associated with data identifying one or more digital coupons that are available to a user. Some or all of the one or more digital coupons may also be associated with other account identifiers associated with the account. In an embodiment, the digital coupons with which the account identifiers are associated are unique instances of corresponding coupon offers, wherein each unique instance has a unique coupon identifier. For example, just as each coupon that may be printed by coupon server 210 may have a unique coupon number, a unique coupon number may also be generated each time a user saves a digital coupon to the user's account. However, in other embodiments, the digital coupons do not require unique coupon identifiers.

Data store 212 may also store other information related to coupon distribution, including device data 217 and distribution logs 218. The device data 217 describes a plurality of devices that execute clients for accessing coupon data 216, such as client 220/228. Each device may be described by one or more device identifiers. Device data 217 may include information such as hardware identifiers, client identifiers, geographic information, and permissions data. In an embodiment, each device identifier is assigned based on a variety of characteristics of the device, in such a manner as to produce device identifiers that are virtually guaranteed to be unique. In an embodiment, the characteristics from which the device identifier are derived include data that cannot easily be changed, so as to ensure that no single device may print more than its allotted share of coupons simply by changing a network address, data file, computer name, or operating system. In an embodiment, the characteristics from which the device identifiers are derived include hardware identifiers such as serial numbers. Techniques for assigning identifiers are described in, for example, U.S. Patent Publication Number 2010/0124235A1, published May 20, 2010, the contents of which are hereby incorporated by reference for all purposes as if fully set forth herein. In other embodiments, however, a device identifier may in fact be a network address, a Mac address, a computer name, a Bluetooth or NFC-based address, and/or a unique client identifier that is generated at the time software for interfacing with coupon server 210 is installed on the client 220/228. In an embodiment, some or all types of device identifiers are associated with a single account in account data 218, thereby allowing a specific account to be identified based on, for example, the client 220/228 providing the device identifier in a token 232 during a transaction at point-of-sale 250, or in communications between the client 220/228 and coupon server 210.

Distribution logs 218 track the number of coupons that have been distributed for each coupon offer described in the coupon data 216, including the number of times coupons have been printed and/or the number of times coupon offers have been saved to a account. Distribution logs 218 may further track how many times each device described in the device data 217 and/or how many times each account described in the account data 214 has printed coupons for, viewed, and/or saved each coupon offer described in coupon data 216.

Data store 212 may optionally store a variety of compensation data. For example, data store 212 may store data indicating, for each coupon, the number of times a retailer 245 has reported the coupon as redeemed. As another example, data store 212 may store balances and account numbers of accounts established by providers 295 from which funds for compensating retailer 245 are to be drawn. Data store 212 may further store account numbers that should be credited in order to provide compensation to retailer 245. Data store 212 may further store a variety of other accounting data.

### Client

In an embodiment, clients 220/228 provide the user with an interface to coupon server 210. Clients 220/228 may be any of variety of computing devices, including a personal computer, printer, phone, or portable computing device. Clients 220/228 may in fact be the same client on the same client device, or clients 220/228 may be separate clients at different devices that are both used by one or more users associated with the same account.

In the depicted embodiment, client 220 is a mobile computing device that is carried with a customer while transacting at point-of-sale 250. Client 220 thus comprises proximity-based interface(s) for wirelessly providing or receiving tokens 232, as described herein. Client 228, by contrast, may be a device that is connected to a printer 229, such as a desktop or laptop computer. However, clients 220/228 need not be restricted to any specific type of computing device, so long as clients 220/228 are capable of providing the functionalities described herein. The various functionalities described herein of clients 220/228 may be implemented by, for example, one or more specialized software applications, a general-purpose web browser, and/or plug-ins to a web browser. In an embodiment, client 220/228 need not necessarily be executed by a device that is owned or even exclusively operated by the user. For example, client 220/228 may be executed by an in-store kiosk provided to customers by retailer 245.

In one embodiment, client 220/228 is a special-purpose computer configured with logic that can perform the operations described herein during operation. In an embodiment, client 220/228 is a general-purpose computer that comprises one or more processors, and memory, mass storage device, or other non-transitory computer-readable storage media storing instructions which, when loaded and executed, cause the one or more processors to perform the operations that are further described herein.

Client 220/228 communicates with coupon server 210 over a network such as the Internet to receive coupon data 224/227. The coupon data 224/227 sent to client 220/228 may include, for instance, a listing of information about coupons available to the user, including offer terms and values. The coupon data 227 further includes data describing a specific coupon offer in sufficient detail to allow client 228 to print a coupon for the coupon offer at printer 229. Printer 229 is any printing device capable of printing a coupon. Printer 229 may be connected to client 228 via any communication mechanism, or client 228 may be integrated into printer 229.

Client 220/228 may, using various input or output mechanisms, allow the user to view a list of available coupon offers, select a particular coupon offer from that list, and choose whether to print a coupon for the offer, or to save the offer to the user's account. In response to the user selecting the latter option, client 220/228 may send a request to coupon server 210 to save the selected offer to the user's account.

In an embodiment, multiple clients 220 may be available to a user, each associated with the same account data. Each client 220/228 potentially supports different mechanisms by which the user may access a coupon offer. For example, one client 220/228 may only allow a user to print coupons via printer 229, another client 220/228 may only allow a user to save digital coupons to an account, and another client 220/228 may allow a user to access coupon offers in both ways.

In an embodiment, coupon data 224/227 and instructions are sent to client 220/228 from a server at an external website, such as a retail website, instead of coupon server 210. In such an embodiment, client-initiated requests to coupon server 210 may or may not be relayed through such an external website.

In an embodiment, client 220/228 includes logic for generating a device identifier, as described in the previous section. Client 220/228 may report this device identifier to coupon server 210 or retail server 240 upon request. Among other purposes, the device identifier may be used by the coupon server 210 for the purpose of enforcing per-device coupon distribution limits.

### Retailer

Retailer 245 is any entity that conducts transactions in which users redeem coupon offers via the coupons distributed by coupon server 210. A user may engage in such transactions with retailer 245 at one or more point-of-sales 250 belonging to the retailer 245, including, for example, one or more brick-and-mortar stores or an online website operated by retailer 245. System 200 may comprise multiple retailers 245, and a single user may utilize the same client 220 to obtain access to some or all of the same coupon offers at each point-of-sale 250 of each retailer 245.

A transaction as used herein refers to the act of a retailer such as retailer 245 obtaining payment for the provision of, or the formation of a contract to provide, certain product(s) and/or service(s), which may collectively be referred to as “items.” Obtaining payment may include receiving a physical or electronic transfer of payment, debiting an account, obtaining a hold on funds, securing funds in escrow, obtaining points or other non-monetary value from an account or escrow or other transfer, or obtaining any form of value from an electronic wallet. A transaction is initiated by a customer's selection of products or services to purchase, followed by the customer's initiation of a checkout process by, for example, clicking on a checkout button or bringing selected products to a checkout register. The checkout process may involve the customer providing the retailer with any information necessary to complete the transaction, such as account or wallet information, billing particulars and/or delivery instructions.

In an embodiment, retailer 245 allows the user to redeem a coupon by simply presenting a printed or digital coupon while engaging in an applicable transaction. The retailer then obtains compensation for accepting the coupon by sending the printed coupon or digital coupon to the optional clearinghouse component of the coupon server, or third party clearinghouse 285. Or, the retailer may simply send a unique identifier printed on a paper coupon, or contained within the redeemed digital coupon, to a clearinghouse.

In an embodiment, retailer 245 allows the user to redeem a coupon by presenting an identifier or token 232 while engaging in a transaction. Retail server 240 uses the identifier or token 232 to locate applicable coupon(s) that have been saved to the user's account. In an embodiment, retail server 240 communicates with coupon server 210 to locate applicable coupon(s) that have been saved to the user's account. In an embodiment, the retail server 240 relies upon coupon server 210 to push coupon availability data for various account identifiers to retail server 240. For example, coupon server 210 may periodically provide retail server 240 with a table of account identifiers and newly associated or disassociated digital coupon identifiers. Retail server 240 may then update a local database based on the coupon availability data. Suitable techniques are described, for instance, in U.S. application Ser. No. 22/878,231, filed Sep. 9, 2010, the entire contents of which are hereby incorporated by reference for all purposes as if fully set forth herein.

Retailer 245 periodically, or in response to a transaction, reports coupon usage data to coupon server 210. Coupon usage data indicates the redemption of one or more coupon offers, along with unique identifiers associated with the redemptions, so that coupons may be removed from the redeeming user's account(s).

In an embodiment, retail server 240 comprises executable logic similar to that of the coupon distribution component for generating coupons. For example, coupon distributor 215 may provide one or more libraries of coupon distribution code for retailer 245 to utilize in retail server 240. As a condition of executing such logic, retail server 240 is configured to communicate periodically via an application program interface with coupon server 210, via which coupon server 210 provides retail server 240 with the coupon data necessary for retail server 240 to generate coupons. For example, coupon server 210 may provide retail server 240 with terms of coupon offers for which customers of retail server 240 are currently eligible, instructions for generating a unique coupon identifier for each coupon offer, and applicable distribution limits and parameters. Retail server 240 is further configured to report distributions to coupon server 210 on a periodic basis.

In an embodiment, retail server 240 is further configured to periodically request compensation for coupons that have been electronically redeemed by retail server 240 and/or for redeemed coupons whose redemption information has been scanned or manually entered. To this end, retail server 240 sends data indicating the coupon identifier of each coupon redeemed during the period. The data may also include data describing the transaction(s) in which the coupon was redeemed, including one or more of sales price(s), transaction date(s) and time(s), and identifiers of product(s) or service(s) included in each transaction. The periodic requests may occur hourly, daily, or upon a certain number of coupon redemptions, for example. The retail server may send requests directly to the clearinghouse component of the coupon server. The retail server may also or instead send requests indirectly, via a server belonging to a clearinghouse agent or to an original coupon provider. In the case of indirect requests, the request is relayed from the intermediate entity to the clearinghouse component of the coupon server with or without additional processing by the intermediate entity.

In an embodiment, retailer 245 is capable of accepting digital coupons from a provider 295 even though retailer 245 is a separate and distinct entity from the provider 295, coupon distributor 215, and clearinghouse 285.

In one embodiment, retail server 240 is a special-purpose computer configured with logic that can perform the operations described herein during operation. In an embodiment, client 220/228 is a general-purpose computer that comprises one or more processors, and memory, mass storage device, or other non-transitory computer-readable storage media storing instructions which, when loaded and executed, cause the one or more processors to perform the operations that are further described herein. Retailer 245 may be a single store, or a corporation that operates a group of stores for which it collectively reports redemptions. In either event, retailer 245 may be compensated by either of direct payment to an individual store that redeemed the coupon or payment to the parent corporation, depending on business rules that may be established between retailer 245 and coupon distributor 215.

### Account Identifiers

An account identifier is a series of characters and/or symbols that uniquely identifies a user or a account associated with the user. For example, an account identifier may identify a retailer's loyalty account, an account with coupon distributor 215, or both. In the latter case, for instance, an account identifier may have been created to identify the retailer's loyalty account, but then subsequently registered with the coupon distributor account, along with potentially other identifiers. An account identifier may or may not also identify or be identified from a physical item, such as a card or personal computing device. In an embodiment, the physical item is any portable item that has an account identifier that can be readily accessed during a transaction.

In an embodiment, an account identifier is a number for a card account, such as a credit card account or customer loyalty card account. A user may provide such an identifier during a transaction by, for example, scanning the card at a card reader, typing or stating the numbers on the card, or providing personal information by which the card number may be located, such as a telephone number.

In an embodiment, an account identifier may be a unique device identifier belonging to a portable computing device. Examples include a mobile phone, laptop or netbook computer, tablet computer, personal digital assistant, flash drive, music player, or camera. For example, the device identifier may be a MAC address, Bluetooth address, serial number, randomly assigned number, phone number, and so forth. A user may provide an account identifier in a token 232 during a transaction by, for example, allowing the portable device to broadcast the account identifier wirelessly to the retailer's checkout system, allowing the retailer to scan the device, or allowing the retailer to see or scan information displayed by the device. In an embodiment, the account identifier does not necessarily correspond to device hardware, but may rather be provided by a software application executing on the device.

In an embodiment, an account identifier is emitted wirelessly by a radio-frequency identifying (RFID) chip or any other mechanism capable of transmitting signals that may be detected during a transaction with retailer 245. For example, the RFID chip may be embedded within a card, device, or other item carried by the user.

In an embodiment, coupon distributor 210 allows the user to print an account identifier, or a barcode representation thereof, on a sheet of paper. The paper may then be presented to the retailer 245 during a transaction. Using this approach, the user can take advantage of the techniques described herein without having to remember the account identifier and without having to present to the retailer 245 an identifying card or device. The paper may or may not be reusable in different transactions at the same or at a different retailer.

In an embodiment, an account identifier may be associated with biometric data that uniquely identifies the user, such as a fingerprint or a retinal scan. Thus, the user may provide the identifier in an embodiment by allowing a retailer to scan the user for the biometric data.

In an embodiment, an account identifier identifies a payment account, such as a credit card account, debit account, or mobile payment account. Such an account identifier is transmitted at the same time as the payment information, thereby avoiding the need to provide separate identifiers and/or tokens 232. In an embodiment, the account identifier is an encrypted account number. In an embodiment, the account identifier is not actually transmitted to the retailer in a token 232. Rather, a transaction identifier is transmitted to the retailer 245 via a token 232. The account identifier is then located using the transaction identifier.

### Payment Server

System 200 optionally includes one or more payment servers 270. Payment server 270 comprises one or more computing devices that collectively function as a server. Payment server 270 communicates with point-of-sales 250, mobile client 220, and/or retail servers 240 at one or more retailers 245 to conduct transactions with customers. Payment server 270 receives payment information for a transaction from point-of-sales 250, mobile client 220, and/or retail servers 240. Payment server 270 verifies whether a payment account identified in the payment information has sufficient funds or credit to engage in a transaction of the amount identified by the payment information. Payment server 270 responds to point-of-sales 250, mobile client 220, and/or retail servers 240 with information indicating whether the transaction is authorized. Payment server 270 then ensures that the funds for the transaction are transferred between financial institution(s) associated with the payment account and the corresponding retailer 245, as appropriate.

In some embodiments, payment server 270 further communicates with coupon server 210 to identify one or more coupon offers associated with identifier(s) and/or token data identified in the payment information. Payment server 270 modifies the transaction details to apply the one or more coupon offers to the transaction. Payment server 270 may then provide information about the applied coupon offers to retailer 245, or payment server 270 may directly seek compensation for applying the one or more coupon offers from an appropriate clearinghouse component.

### Third Party Clearinghouse

System 200 also optionally includes one or more third-party clearinghouses 285. In some embodiments, some or all coupons may be cleared at one or more clearinghouses 285 that are operated by a third-party entity, other than the coupon distributor 215. Coupon providers 295 coordinate with clearinghouse(s) 285 to provide funds directly to retailers, including retailer 245. Retailers 245 provide information about redeemed digital and/or printed coupons directly to clearinghouse(s) 285 electronically and/or via mail. Clearinghouse(s) 285 then compensate retailers 245, as discussed herein. Some or all clearinghouses 285 may comprise one or more computing devices that collectively implement a clearinghouse component such as described above with respect to coupon server 210.

Optionally, coupon distributor 215 acts as an agent for third-party clearinghouse 285 for some or all coupons. The coupon distributor 215 still compensates retailer 245 directly, but coupon providers 295 maintain their accounts at clearinghouse 285. Thus, coupon distributor 215 forwards data for redeemed coupons to the clearinghouse 285 in any suitable form, including electronically or by mail. Clearinghouse 285 then reimburses coupon distributor 215 from the funds held for coupon provider 295.

### XIV. Implementation Mechanism—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

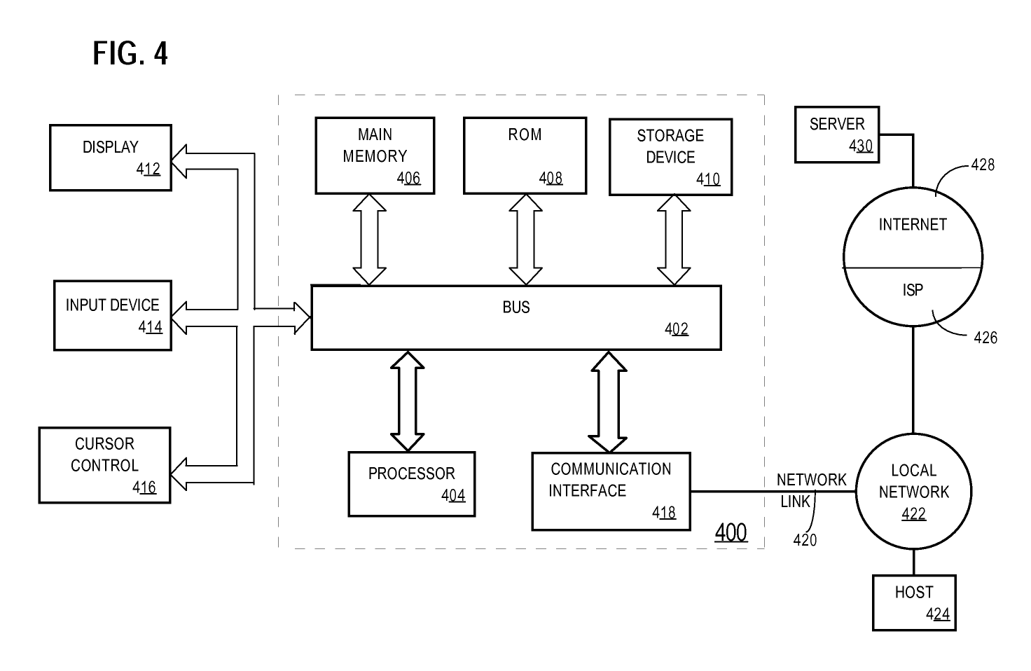

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### XV. Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
at a point-of-sale terminal belonging to a retailer, receiving basket data specifying one or more item identifiers for one or more items to purchase in a transaction;
at a sensor coupled to the point-of-sale terminal, receiving a wireless signal from a mobile device, the wireless signal carrying token data;
locating an identifier based on the token data;
sending a request over a network to a coupon server, the request comprising the identifier, wherein the coupon server is a server configured to receive requests that include identifiers from a plurality of different retailers;
responsive to the request, receiving from the coupon server digital coupon availability data, the digital coupon availability data specifying one or more coupon offers available to an account associated with the identifier;
comparing the one or more item identifiers in the basket to one or more item identifiers associated with the one or more coupon offers specified in the digital coupon availability data to identify a particular coupon offer to apply to the transaction;
applying the particular coupon offer to the transaction by adjusting a total amount to charge for the transaction in accordance with one or more terms of the particular coupon offer;
sending transaction information and at least a portion of the token data to a payment server, wherein the transaction information specifies the adjusted total amount to charge for the transaction;
receiving, from the payment server, an indication that the transaction has been authorized;
providing to the terminal an indication that the transaction has successfully completed;
wherein the method is performed by one or more computing devices.

2. The method of claim 1, wherein receiving the wireless signal comprises receiving a signal via a Near-Field Communications reader.

3. The method of claim 1, wherein the identifier is one of an account identifier, device identifier, or payment identifier specified in the token data.

4. The method of claim 1, wherein the portion of the token data sent to the payment server is the identifier sent to the coupon server.

5. The method of claim 1, wherein the coupon server is the same as the payment server.

6. The method of claim 1, wherein at least the steps of locating the identifier, sending the request, receiving the digital coupon availability data, comparing the one or more item identifiers, and sending the transaction information are performed by a retail server coupled to the terminal.

7. A method comprising:
receiving, at a server, coupon data from a plurality of coupon providers, the coupon data specifying a plurality of different coupon offers for which the coupon server is to distribute digital coupons;
receiving, at the server, registration data for a plurality of accounts, each account associated with one or more Near Field Communication tokens;
the server storing account data associating different sets of one or more digital coupons for the plurality of different coupon offers with different accounts of the plurality of accounts;
receiving, at the server, requests for digital coupon availability data, each particular request of the requests including a particular Near Field Communication token;
responsive to each particular request of the requests: identifying a particular account associated with the particular request; identifying a set of one or more digital coupons associated with the particular account; and sending particular digital coupon availability data in response to the particular request, the particular digital coupon availability data specifying the set of one or more digital coupons;
wherein the method is performed by one or more computing devices.

8. The method of claim 7, wherein the requests are from a plurality of different retail servers operated by a plurality of different retailers.

9. The method of claim 7, wherein the requests are from one or more payment servers.

10. The method of claim 7, wherein each particular request includes basket data specifying one or more item identifiers involved in a transaction associated with the particular request, wherein identifying a set of one or more digital coupons associated with the particular account comprises selecting the set of one or more digital coupons from a plurality of digital coupons associated with the particular account based on the item identifiers.

11. A method comprising:
receiving, at a server, registration data for a plurality of payment accounts, each payment account associated with one or more Near Field Communication tokens;
receiving, at the server, transaction requests from a plurality of different retailers to complete transactions at a plurality of different points-of-sale operated by the plurality of different retailers;
wherein each particular transaction request of the plurality of transaction requests includes particular transaction information specifying particular basket data comprising one or more item identifiers involved in a particular transaction associated with the particular transaction request, and a particular Near Field Communication token;
responsive to each particular transaction request of the plurality of transaction requests, the server:
sending the particular Near Field Communication token corresponding to the particular transaction request to a coupon server;
receiving, from the coupon server, data describing one or more digital coupons associated with the particular Near Field Communication token;
identifying at least a particular digital coupon of the one or more digital coupons to apply to the particular transaction information;
calculating a total transaction amount based on applying at least the particular digital coupon to the particular transaction information; and
causing a particular retailer that sent the particular transaction request to receive funds based on the calculated total transaction amount;
wherein the method is performed by one or more computing devices.

12. The method of claim 11, further comprising, responsive to each particular transaction request of the plurality of transaction requests, the server sending the particular basket data to the coupon server in association with the particular Near Field Communication token.

13. The method of claim 11, further comprising, responsive to each particular transaction request of the plurality of transaction requests, the server comparing the particular basket data to the data describing the one or more digital coupons to identify which particular digital coupon to apply to the particular transaction information.

14. The method of claim 11, wherein the server receives the same Near Field Communication token in different transaction requests from different retailers of the plurality of retailers.

15. The method of claim 11, wherein the coupon server is a component of the server.

16. A system comprising:
a coupon server, executing at a first set of one or more computing devices, configured to: receive coupon data from a plurality of coupon providers, the coupon data specifying a plurality of coupon offers for which the coupon server distributes digital coupons; and provide digital coupons for one or more selected coupon offers of the plurality of coupon offers in response to coupon requests received over one or more networks;
a payment server, executing at a second set of one or more computing devices, configured to: receive payment requests over the one or more networks, the payments requests indicating amounts to charge particular payment accounts; and respond to the payment requests over the one or more networks with responses indicating whether each particular payment request was authorized;
wherein the coupon server and the payment server are further configured to receive, in particular requests over the one or more networks, particular token data sensed in wireless signals during transactions at terminals belonging to a plurality of different retailers;
one or more database systems storing mapping data that associates token data with payment accounts and coupon accounts;
wherein the coupon server is further configured to, for each particular coupon request of a plurality of the coupon requests: identify a coupon account associated with particular token data included in the particular coupon request; select one or more coupon offers associated with the account; and respond to the particular coupon request with digital coupon information for the one or more coupon offers associated with the account;
wherein the payment server is further configured to, for each particular payment request of a plurality of the payment requests: identify a payment account associated with particular token data included in the particular payment request; and based on the payment account, determine whether to authorize a transaction associated with the particular payment request.

17. The system of claim 16, further comprising:
retail servers belonging to the plurality of different retailers, executing at a plurality of third sets of one or more computing devices, each coupled to a different set of the terminals and one or both of the payment server and coupon server;
wherein the retail servers are configured to, responsive to a first request from a first terminal that includes first token data, send a first coupon request comprising the first token data to the coupon server and send a first payment request comprising the same first token data to the payment server.

18. The system of claim 16, wherein each particular token data is a Near Field Communication token.

19. The system of claim 16, wherein the first set of computing devices is the same as the second set of computing devices.

20. The system of claim 16, wherein the payment server is further configured to: send at least some of the coupon requests to the coupon server; and apply digital coupons provided by the coupon server to transactions described in the payment requests.
